(19) United States
(12) Patent Application Publication
(10) Pub. No.: US 2009/0202241 A1
(43) Pub. Date: Aug. 13, 2009

(54) Optical Communication System And Method For Distributing Content Aboard A Mobile Platform During Travel

(75) Inventors: Jin Yu, Irvine, CA (US); Randy K. Schwarz, Santa Ana, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Panasonic Avionics Corporation

(21) Appl. No.: 12/367,406

(22) Filed: Feb. 6, 2009

Related U.S. Application Data
(60) Provisional application No. 61/027,315, filed on Feb. 8, 2008.

(51) Int. Cl. H04J 14/00

(52) U.S. Cl. 398/58

(57) ABSTRACT

An optical distribution system for vehicle information systems installed aboard passenger vehicles, such as automobiles and aircraft, and methods for manufacturing and using same. Each system resource of the vehicle information system couples with the optical distribution system via an optical transceiver system. The optical transceiver systems provide a link interface between the system resources and the optical distribution system for supporting the transmission and reception of optical communication signals among the system resources via the optical distribution system. The optical distribution system couples the system resources via fiber optic communication connections that can support high data transfer rates. Being light weight, compact, and requiring little, if any, electrical power, the optical distribution system advantageously supports full communications among the system resources of the vehicle information system, while reducing the costs of operating and transporting the vehicle information system aboard the passenger vehicle.

### CROSS-REFERENCE TO RELATED APPLICATIONS

This application claims priority to U.S. provisional patent application Ser. No. 61/027,315, filed on Feb. 8, 2008. Priority to the provisional patent application is expressly claimed, and the disclosure of the provisional application is hereby incorporated herein by reference in its entirety and for all purposes.

### FIELD

The present disclosure relates generally to data distribution systems and more particularly, but not exclusively, to communication infrastructures installed aboard passenger vehicles that provide bandwidth for entertainment services, such as video on demand.

### BACKGROUND

It presently is mature in technology and economics to provide services of large bandwidth to residential as well as enterprise through interconnected workstations. The extension of such application to mobile applications, such as vehicle information systems, has gained huge interest. For example, airlines have experienced great demand for installation of in-flight entertainment systems aboard their aircraft to enhance the in-flight experience of their passengers during travel.

One advanced in-flight entertainment service that requires high bandwidth is video-on-demand (VOD). A generic network infrastructure for vehicle information (or entertainment) systems comprises a centralized server called head end to host the content media, an end terminal on each passenger seat to present the video content, and a content distribution system disposed between the server and the end terminals. In response to a service request from a selected passenger seat, the head end delivers the video content to the selected passenger seat via the content distribution system.

Based upon typical industry requirements, vehicle information systems should be light, of small size, and consume minimum electrical power. Although significant efforts have been made to optimize the head end and the end terminals, the content distribution system remains far from being optimized, for example, in terms of the cost to carry it on board. Basically, the content distribution system is still mainly metal wire based and needs electrical power. In fact, currently-available content distribution systems alone command significant portions of the total system allowances for weight, space, and power consumption. These limitations often translate into a significant amount of money required for vehicle operators to offer and maintain the vehicle information systems.

In view of the foregoing, a need exists for an improved content distribution system and method for distributing content during travel in an effort to overcome the aforementioned obstacles and deficiencies of conventional vehicle information systems.

### BRIEF DESCRIPTION OF THE DRAWINGS

FIG. 1 is an exemplary top-level drawing illustrating an embodiment of an information system, wherein the information system includes an optical distribution system that couples at least one content source with one or more user systems.

FIG. 2A is an exemplary top-level drawing illustrating the information system of FIG. 1, wherein the information system comprises a vehicle information system installed aboard an automobile.

FIG. 2B is an exemplary top-level drawing illustrating an alternative embodiment of the vehicle information system of FIG. 2A, wherein the vehicle information system is installed aboard an aircraft.

FIG. 3A is an exemplary top-level drawing illustrating an embodiment of a passenger cabin of a passenger vehicle, wherein the vehicle information system of FIGS. 2A-B has been installed.

FIG. 33B is an exemplary top-level drawing illustrating an alternative embodiment of the vehicle information system of FIG. 4A, wherein the vehicle information system is in communication with a personal media device.

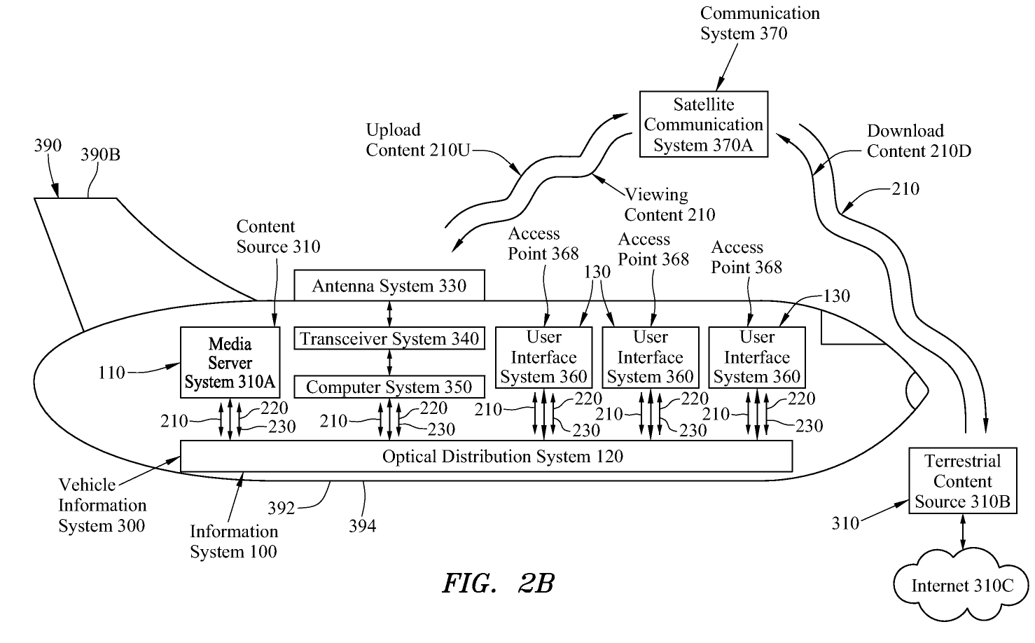

FIG. 4 is an exemplary detail drawing illustrating a conventional distribution system for the vehicle information systems of FIGS. 2A-B.

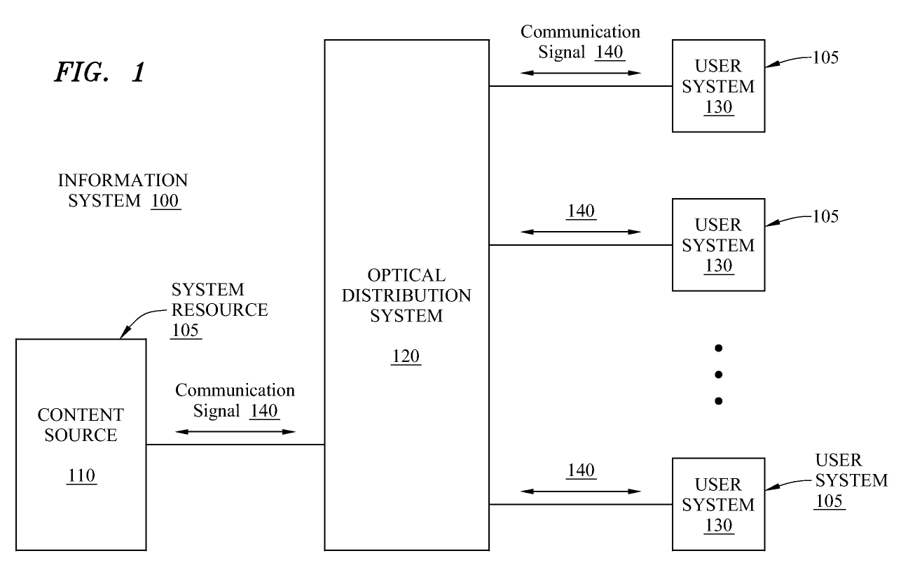

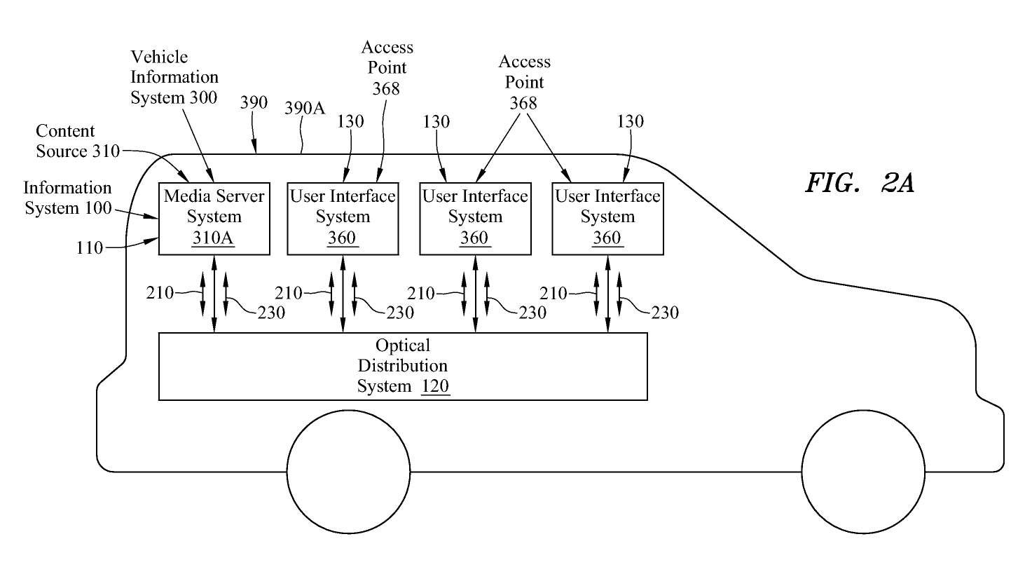

FIG. 5 is an exemplary detail drawing illustrating an embodiment of the optical distribution system of FIG. 1, wherein the optical distribution system includes at least one optical splitter/combiner system.

FIG. 6A is an exemplary detail drawing illustrating an embodiment of the optical splitter/combiner system of FIG. 5.

FIG. 6B is an exemplary detail drawing illustrating an alternative embodiment of the optical splitter/combiner system of FIG. 5, wherein the optical splitter/combiner system is provided as a multi-stage optical splitter/combiner system.

FIGS. 7A-D are an exemplary timing diagrams illustrating data streams output by selected user interface systems of the vehicle information systems of FIGS. 2A-B.

FIG. 7E is an exemplary timing diagram illustrating a composite data stream output by a selected optical splitter/combiner system of the optical distribution system of FIG. 5, wherein the selected optical splitter/combiner system receives the data streams output by selected user interface systems of FIGS. 7A-D.

FIG. 8A is an exemplary detail drawing illustrating an alternative embodiment of the optical distribution system of FIG. 1, wherein the optical distribution system includes one or more wavelength-division multiplexer (WDM) systems.

FIG. 8B is an exemplary detail drawing illustrating an alternative embodiment of the optical distribution system of FIG. 8A, wherein the one wavelength-division multiplexer systems communicate via a optical splitter/combiner system.

FIG. 9A is an exemplary detail drawing illustrating another alternative embodiment of the optical distribution system of FIG. 1, wherein the optical distribution system provides redundant optical communication connections among system resources.

FIG. 9B is an exemplary detail drawing illustrating an alternative embodiment of the optical distribution system of FIG. 9A, wherein the optical distribution system provides redundant optical communication connections between a head end system and a group of user interface systems.

FIG. 10A is an exemplary detail drawing illustrating an embodiment of a system component of the optical distribution system of FIG. 1, wherein the system component includes an optical communication port (or connector) that is coupled with an optical communication port (or connector) of an optical communication connection.

FIG. 10B is an exemplary detail drawing illustrating an alternative embodiment of the system component of FIG. 10A, wherein the optical communication port of the system component is decoupled from the optical communication port of the optical communication connection.

FIG. 11A is an exemplary detail drawing illustrating an embodiment of a pair of optical communication connections of the optical distribution system of FIG. 1, wherein the optical communication connections each include an optical communication port (or connector) and are coupled via an optical adapter system.

FIG. 11B is an exemplary detail drawing illustrating an alternative embodiment of the pair of optical communication connections of FIG. 11A, wherein the optical communication ports of the optical communication connections are decoupled from the optical adapter system.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Since currently-available information systems incorporate content distribution systems that command significant portions of the total system allowances for weight, space, and power consumption, an optical content distribution system that is light weight, compact, and requires little, if any, electrical power can prove desirable and provide a basis for a wide range of system applications, such as vehicle information systems for use aboard automobiles, aircraft, and other types of vehicles during travel. This result can be achieved, according to one embodiment disclosed herein, by an information system 100 as illustrated in FIG. 1.

Turning to FIG. 1, the information system 100 can include an optical distribution system 120 for distributing communication signals 140 among a plurality of conventional system resources 105, such as one or more server systems, workstations, mass storage systems, and/or a printing systems, without limitation. Preferably being configured to support high data transfer rates, the optical distribution system 120 can comprises a plurality of conventional fiber optic communication connections 128 (shown in FIG. 5), such as optical fibers, and is shown as coupling at least one content source 110 with one or more user systems 130. The communication signals 140 thereby can comprise optical communication signals 140B (shown in FIG. 5), such as optical data signals, that propagate between the content source 110 and a selected user system 130 via the optical communication connections 128 of the optical distribution system 120. As desired, the optical communication connections 128 can be trunked and/or can support a selected duplex mode, such as a half duplex mode and/or a full duplex mode, with each of the system resources 105.

The optical distribution system 120 likewise can be provided with any appropriate topology, protocol, and/or architecture. Comprising a geometric arrangement of the system resources 105, common network topologies include mesh, star, bus, ring, and daisy-chain network topologies. The topology of the optical distribution system 120 likewise can comprise a hybrid of the common network topologies, such as a network tree topology. Network protocols define a common set of rules and signals by which the system resources 105 can communicate via the optical distribution system 120. Illustrative types of network protocols include Ethernet and Token-Ring network protocols; whereas, peer-to-peer and client/server network architectures are examples of typical network architectures. It will be appreciated that the network system types, topologies, protocols, and architectures identified above are merely exemplary and not exhaustive.

Since the optical communication connections 128 typically are light weight, compact, and require no electrical power, the optical distribution system 120 can be advantageously applied in a variety of system applications. Although the optical distribution system 120 may be used in conjunction with information systems 100 that are disposed in fixed locations, such as buildings, the optical distribution system 120 likewise can advantageously be applied in portable system applications. Turning to FIGS. 2A-B, for example, the optical distribution system 120 can be applied in a vehicle information system 300 that can be configured for installation aboard a wide variety of vehicles 600. Exemplary types of vehicles can include an automobile 390A (shown in FIG. 2A), an aircraft 390B (shown in FIG. 2B), a bus, a recreational vehicle, a boat, and/or a locomotive, or any other type of passenger vehicle without limitation. If installed on an aircraft 390B as illustrated in FIG. 2B, for example, the vehicle information system 300 can comprise a conventional aircraft passenger in-flight entertainment system, such as the Series 2000, 3000, eFX, and/or eX2 in-flight entertainment system as manufactured by Panasonic Avionics Corporation (formerly known as Matsushita Avionics Systems Corporation) of Lake Forest, Calif.

As shown in FIGS. 2A-B, the vehicle information system 300 comprises at least one conventional content source 310 and one or more user (or passenger) interface systems 360 that communicate in real time via the optical distribution system 120. Each content source 310 can be provided in the manner set forth in the co-pending U.S. patent applications “SYSTEM AND METHOD FOR DOWNLOADING FILES,” Ser. No. 10/772,565, filed on Feb. 4, 2004; entitled “SYSTEM AND METHOD FOR MANAGING CONTENT ON MOBILE PLATFORMS,” Ser. No. 11/123,327, filed on May 6, 2005; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005; entitled “SYSTEM AND METHOD FOR INTERFACING A PORTABLE MEDIA DEVICE WITH A VEHICLE INFORMATION SYSTEM,” Ser. No. 12/210,624, filed on Sep. 15, 2008; and “PORTABLE USER CONTROL DEVICE AND METHOD FOR VEHICLE INFORMATION SYSTEMS,” Ser. No. 12/210,689, filed on Sep. 15, 2008, which are assigned to the assignee of the present application and the respective disclosures of which are hereby incorporated herein by reference in their entireties.

The content sources 310 can include one or more internal content sources, such as server system 310A, that are installed aboard the vehicle 390 and/or remote (or terrestrial) content sources 310B that can be external from the vehicle 390. The server system 310A can be provided as an information system controller for providing overall system control functions for the vehicle information system 300 and/or at least one media (or file) server system, as illustrated in FIGS. 2A-B), for storing preprogrammed content and/or downloaded viewing content 210D, as desired. The server system 310A can include, and/or communicate with, one or more conventional peripheral media storage systems (not shown), including optical media devices, such as a digital video disk (DVD) system or a compact disk (CD) system, and/or magnetic media systems, such as a video cassette recorder (VCR) system or a hard disk drive (HDD) system, of any suitable kind, for storing the preprogrammed content and/or the downloaded viewing content 210D.

The viewing content 210 can comprise any conventional type of audio and/or video viewing content as set forth in the above-referenced co-pending U.S. patent applications, entitled “SYSTEM AND METHOD FOR DOWNLOADING FILES,” Ser. No. 10/772,565, filed on Feb. 4, 2004; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005.

As desired, the viewing content 210 can include geographical information in the manner set forth in U.S. Pat. No. 6,661,353, entitled “METHOD FOR DISPLAYING INTERACTIVE FLIGHT MAP INFORMATION,” which is assigned to the assignee of the present application and the disclosure of which is hereby incorporated herein by reference in its entirety. Alternatively, and/or additionally, to entertainment content, such as live satellite television programming and/or live satellite radio programming, the viewing content likewise can include two-way communications, such as real-time access to the Internet 310C (shown in FIG. 2B) and/or telecommunications in the manner set forth in U.S. Pat. No. 5,568,484, entitled “TELECOMMUNICATIONS SYSTEM AND METHOD FOR USE ON COMMERCIAL AIRCRAFT AND OTHER VEHICLES,” which is assigned to the assignee of the present application and the disclosure of which is hereby incorporated herein by reference in its entirety. The viewing content 210 likewise can include advertising content provided in the manner set forth in the co-pending United States patent application, entitled “SYSTEM AND METHOD FOR PRESENTING ADVERTISEMENT CONTENT ON A MOBILE PLATFORM DURING TRAVEL,” Ser. No. 12/245,521, filed on Oct. 3, 2008, the disclosure of which is hereby incorporated herein by reference in its entirety. It is understood that the exemplary viewing content as shown and described herein are not exhaustive and are provided herein for purposes of illustration only and not for purposes of limitation.

Being configured to distribute and/or present the viewing content 210 provided by one or more selected content sources 310, the vehicle information system 300 can communicate with the content sources 310 in real time and in any conventional manner, including via wired and/or wireless communications. The vehicle information system 300 and the terrestrial content source 310B, for example, can communicate in any conventional wireless manner, including directly and/or indirectly via an intermediate communication system 370, such as a satellite communication system 370A. The vehicle information system 300 thereby can receive download viewing content 210D from a selected terrestrial content source 310B and/or transmit upload viewing content 210U, including navigation and other control instructions, to the terrestrial content source 310B. As desired, the terrestrial content source 310B can be configured to communicate with other terrestrial content sources (not shown). The terrestrial content source 310B is shown in FIG. 2B as providing access to the Internet 310C. Although shown and described as comprising the satellite communication system 370A for purposes of illustration, it is understood that the communication system 370 can comprise any conventional type of wireless communication system, such as a cellular communication system (not shown) and/or an Aircraft Ground Information System (AGIS) communication system (not shown).

To facilitate communications with the terrestrial content sources 310B, the vehicle information system 300 can include an antenna system 330 and a transceiver system 340 for receiving the viewing content from the remote (or terrestrial) content sources 310B as shown in FIGS. 2A-B. The antenna system 330 preferably is disposed outside the vehicle 390, such as an exterior surface 394 of a fuselage 392 of the aircraft 390B. The antenna system 330 can receive viewing content 210 from the terrestrial content source 310B and provide the received viewing content 210, as processed by the transceiver system 340, to a computer system 350 of the vehicle information system 300. The computer system 350 can provide the received viewing content 210 to the media (or content) server system 310A and/or to one or more of the user interface systems 360, as desired. Although shown and described as being separate systems for purposes of illustration, the computer system 350 and the media server system 310A can be at least partially integrated.

The user interface systems 360 are provided for selecting viewing content 210 and for presenting the selected viewing content 210. As desired, the user interface systems 360 can comprise conventional passenger interfaces and can be provided in the manner set forth in the above-referenced co-pending U.S. patent application, entitled “PORTABLE MEDIA DEVICE AND METHOD FOR PRESENTING VIEWING CONTENT DURING TRAVEL,” Ser. No. 11/154,749, filed on Jun. 15, 2005, as well as in the manner set forth in the co-pending U.S. patent application, entitled “SYSTEM AND METHOD FOR PRESENTING HIGH-QUALITY VIDEO TO PASSENGERS ON A MOBILE PLATFORM,” Ser. No. 11/379,360, filed on Apr. 19, 2006, the disclosure of which is hereby incorporated herein by reference in its entirety.

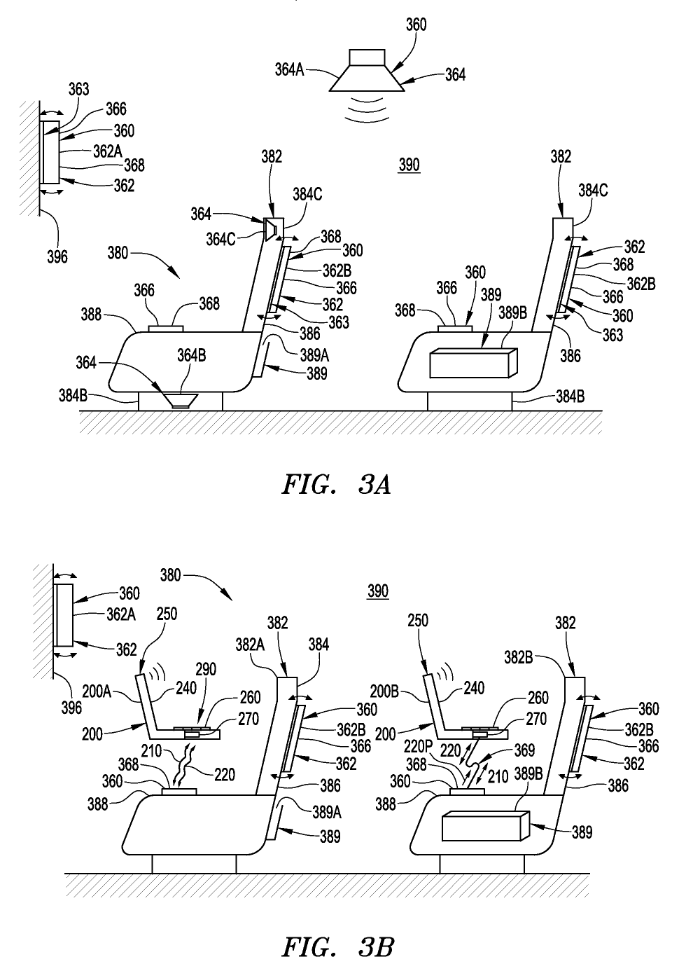

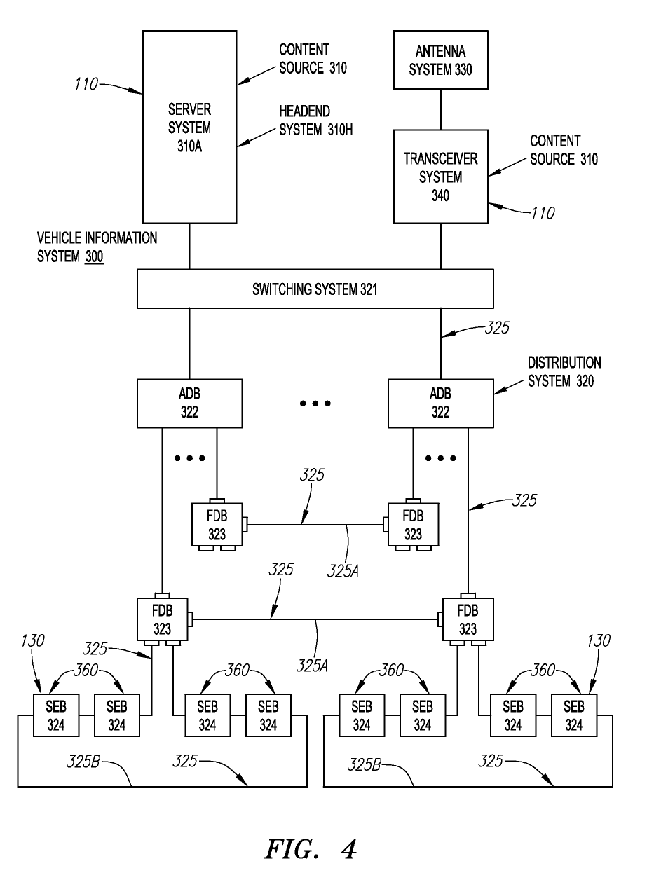

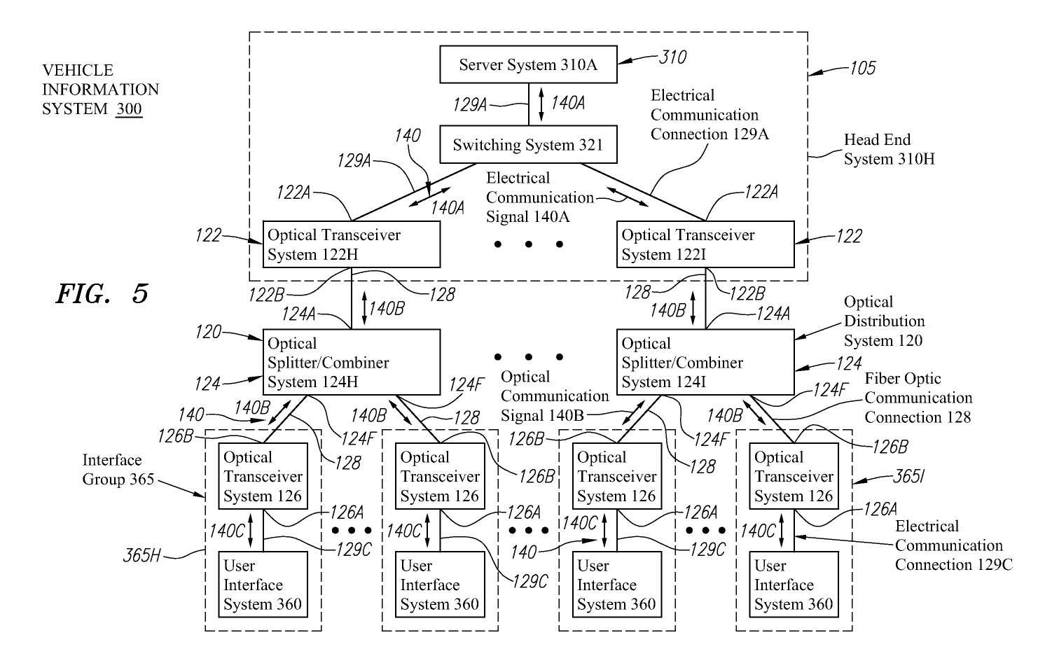

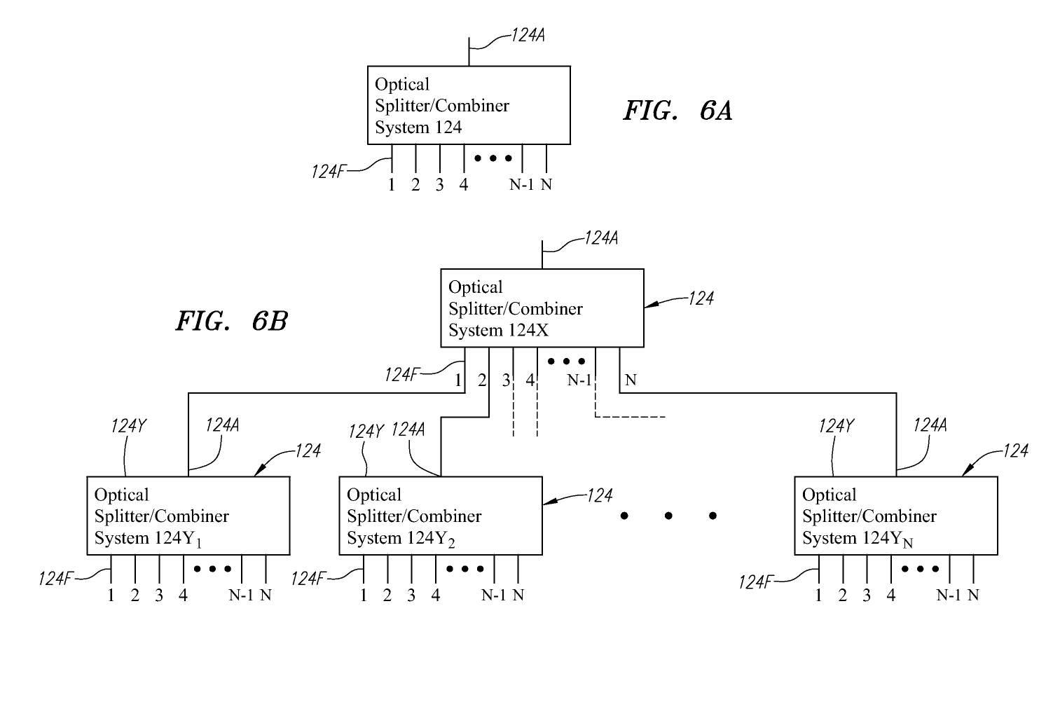

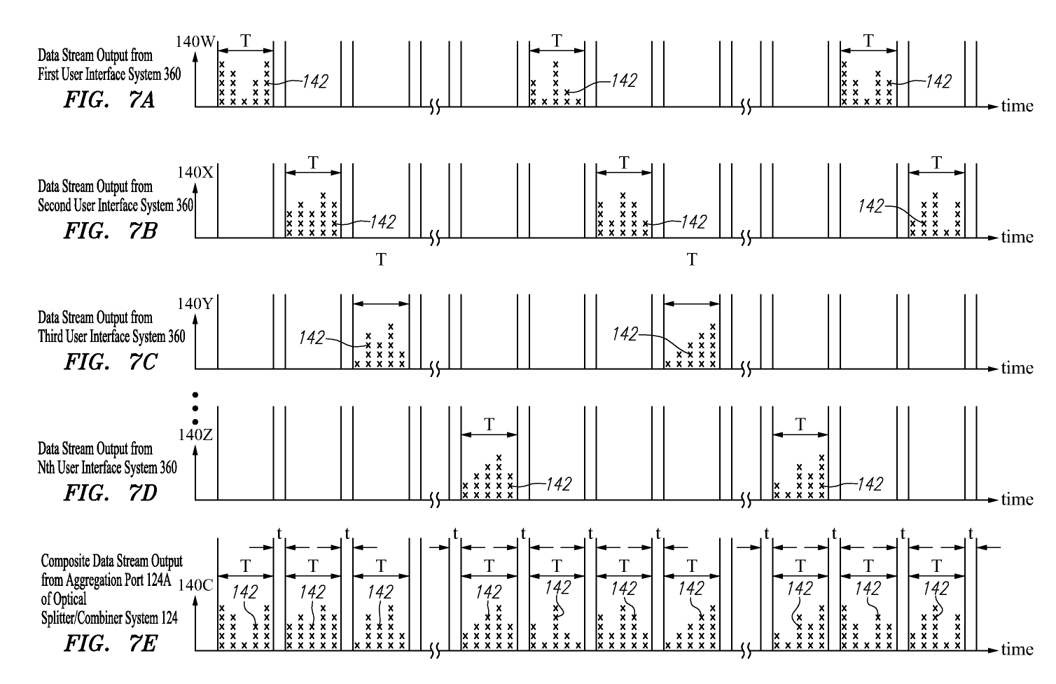

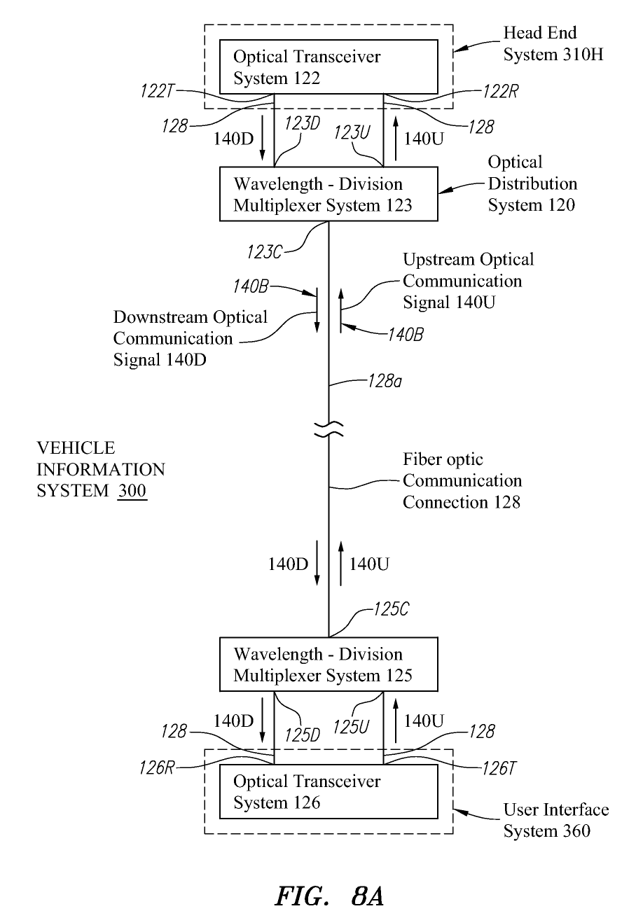

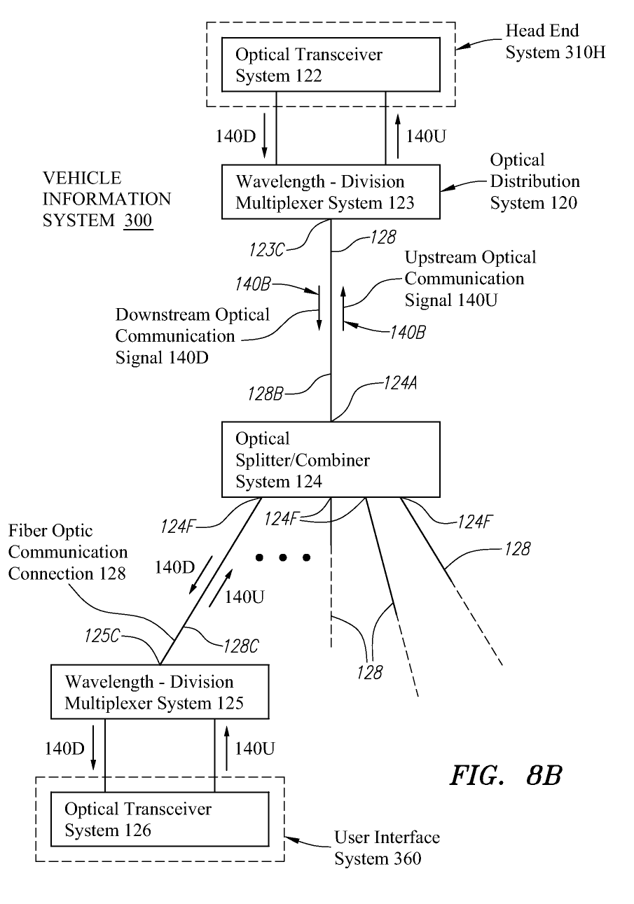

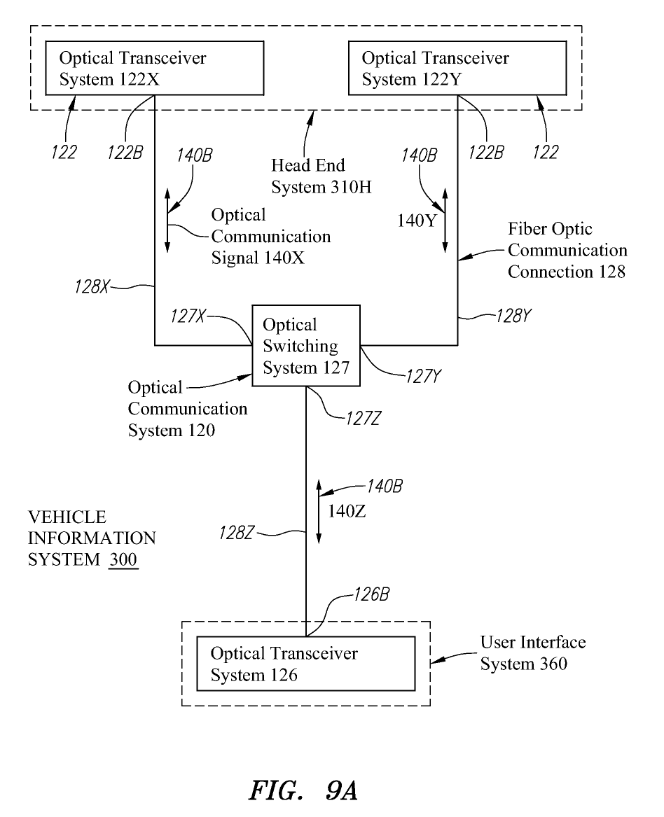

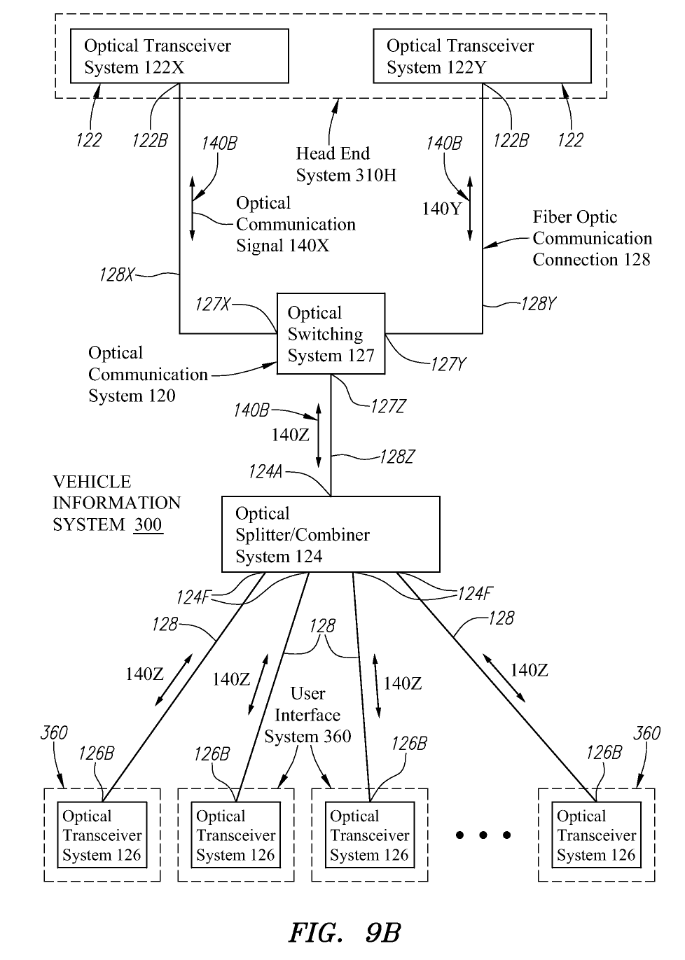

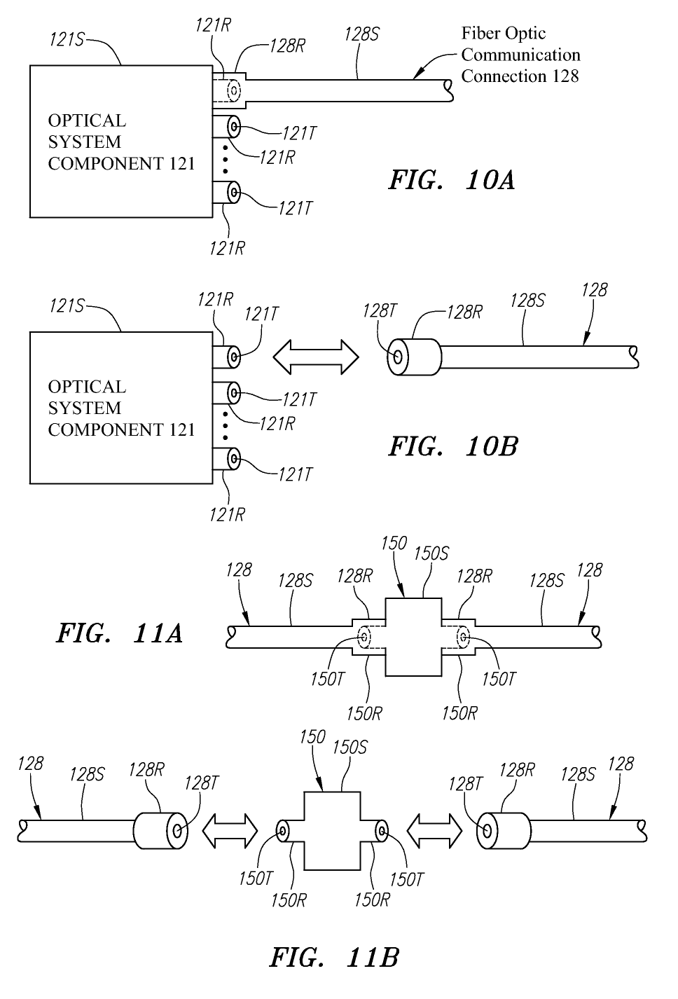

FIG. 3A provides a view of a passenger cabin 380 of a passenger vehicle 390, such as the automobile 390A (shown in FIG. 2A) and/or the aircraft 390B (shown in FIG. 2B), aboard which the vehicle information system 300 has been installed. The passenger cabin 380 is illustrated as including a plurality of passenger seats 382, and each passenger seat 382 is associated with a selected user interface system 360. Each user interface system 360 can include a video interface system 362 and/or an audio interface system 364. Exemplary video interface systems 362 can include overhead cabin display systems 362A with central controls, seatback display systems 362B or armrest display systems (not shown) each with individualized controls, crew display panels, and/or handheld presentation systems. The audio interface systems 364 can be provided in any conventional manner, including an overhead speaker system 364A, the handheld presentation systems, and/or headphones coupled with an audio jack provided, for example, at an armrest 388 of the passenger seat 382. A speaker system likewise can be associated with the passenger seat 382, such as a speaker system 364B disposed within a base 384B of the passenger seat 382 and/or a speaker system 364C disposed within a headrest 384C of the passenger seat 382. In a preferred embodiment, the audio interface system 364 can include an optional noise-cancellation system for further improving sound quality produced by the audio interface system 364.

The video interface systems 362 and the audio interface systems 364 can be installed at any suitable cabin surface, such as a seatback 386, wall 396, ceiling, and/or bulkhead, or an armrest 388 of a passenger seat 382 in any conventional manner including via a mounting system 363 provided in the manner set forth co-pending U.S. patent applications, entitled “SYSTEM AND METHOD FOR MOUNTING USER INTERFACE DEVICES,” Ser. No. 11/828,193, filed on Jul. 25, 2007, and entitled “USER INTERFACE DEVICE AND METHOD FOR PRESENTING VIEWING CONTENT,” Ser. No. 11/835,371, filed on Aug. 7, 2007, which are assigned to the assignee of the present application and the respective disclosures of which are hereby incorporated herein by reference in their entireties.

As shown in FIG. 3A, the user interface system 360 likewise can include a user input system 366 for permitting the user (or passenger) to communicate with the vehicle information system 300, such as via an exchange of control signals 220. For example, the user input system 366 can permit the user to enter one or more user instructions 230 for controlling the operation of the vehicle information system 300. Illustrative user instructions 230 can include instructions for initiating communication with the content source 310, instructions for selecting viewing content 210 for presentation, and/or instructions for controlling the presentation of the selected viewing content 210. If a fee is required for accessing the viewing content 210, payment information likewise can be entered via the user input system 366.

The user input system 366 can be provided in any conventional manner and typically can include one or more switches (or pushbuttons), such as a keyboard or a keypad, and/or a pointing device, such as a mouse, trackball, or stylus. As desired, the user input system 366 can be at least partially integrated with, and/or separable from, the associated video interface system 362 and/or audio interface system 364. For example, the video interface system 362 and the user input system 366 can be provided as a touchscreen display system. The user input system 366 likewise can include one or more input ports (not shown) for coupling a peripheral input device (not shown), such as a full-size computer keyboard, an external mouse, and/or a game pad, with the vehicle information system 300.

Preferably, at least one of the user interface systems 360 includes a wired and/or wireless access point 368, such as a conventional communication port (or connector), for coupling a personal media device 200 (shown in FIG. 3B) with the vehicle information system 300. Passengers (or users) who are traveling aboard the vehicle 390 thereby can enjoy personally-selected viewing content during travel. The access point 368 is located proximally to an associated passenger seat 382 and can be provided at any suitable cabin surface, such as a seatback 386, wall 396, ceiling, and/or bulkhead.

Turning to FIG. 3B, the vehicle information system 300 is shown as communicating with one or more personal media devices 200. Each personal media device 200 can store the audio and/or video viewing content 210 and can be provided as a handheld device, such as a laptop computer, a palmtop computer, a personal digital assistant (PDA), cellular telephone, an iPod® digital electronic media device, an iPhone® digital electronic media device, and/or a MPEG Audio Layer 3 (MP3) device. Illustrative personal media devices 200 are shown and described in the co-pending U.S. patent applications, entitled “SYSTEM AND METHOD FOR DOWNLOADING FILES,” Ser. No. 10/772,565, filed on Feb. 4, 2004; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005; entitled “SYSTEM AND METHOD FOR INTERFACING A PORTABLE MEDIA DEVICE WITH A VEHICLE INFORMATION SYSTEM,” Ser. No. 12/210,624, filed on Sep. 15, 2008; entitled “MEDIA DEVICE INTERFACE SYSTEM AND METHOD FOR VEHICLE INFORMATION SYSTEMS,” Ser. No. 12/210,636, filed on Sep. 15, 2008; entitled “MEDIA DEVICE INTERFACE SYSTEM AND METHOD FOR VEHICLE INFORMATION SYSTEMS,” Ser. No. 12/210,652, filed on Sep. 15, 2008; and “PORTABLE USER CONTROL DEVICE AND METHOD FOR VEHICLE INFORMATION SYSTEMS,” Ser. No. 12/210,689, filed on Sep. 15, 2008, which are assigned to the assignee of the present application and the respective disclosures of which are hereby incorporated herein by reference in their entireties.

The illustrated personal media devices 200 each include a video display system 240 for visually presenting the viewing content 210 and an audio system 250 for audibly presenting the viewing content 210. Each personal media device 200 can include a user control system 260, which can be provided in any conventional manner and typically includes one or more switches (or pushbuttons), such as a keyboard or a keypad, and/or a pointing device, such as a mouse, trackball, or stylus. The personal media devices 200 thereby can select desired viewing content 210 and control the manner in which the selected viewing content 210 is received and/or presented.

The personal media devices 200 likewise include a communication port (or connector) 270. The communication port 270 enables the personal media devices 200 to communicate with the vehicle information system 300 via the access points 368 of the user interface systems 360. As illustrated with personal media device 200A, the communication port 270 and the access points 368 can supported wireless communications; whereas, support for wired communications between the communication port 270 and the access points 368 via a communication cable assembly 369 is shown with personal media device 200B. When the communication port 270 and the access points 368 are in communication, the vehicle information system 300 supports a simple manner for permitting the associated personal media device 200 to be integrated with the vehicle information system 300 using a user-friendly communication interface.

When the personal media device 200 and the vehicle information system 300 are in communication, the vehicle information system 300 can perform a plurality of integration tasks simultaneously, enabling the personal media device 200 to become fully integrated with the vehicle information system 300 via a selected access point 368. The system elements of the vehicle information system 300 and the personal media device 200 thereby become interchangeable. The personal media device 200 likewise can receive control signals (or commands) 220 and/or operating power 220P from the vehicle information system 300. Thereby, the personal media device 200 advantageously can become a seamless part of the vehicle information system 300.

For example, user instructions 230 (shown in FIGS. 2A-B) for controlling the operation of the vehicle information system 300 can be provided via the user input system 366 of the vehicle information system 300 and/or the user control system 260 of the personal media device 200. In other words, the user input system 366 of the vehicle information system 300 and/or the user control system 260 of the personal media device 200 can be used to select viewing content 210 and control the manner in which the selected viewing content 210 is received and/or presented. The selected viewing content 210 can be provided by a relevant content source 310 (shown in FIGS. 2A-B) of the vehicle information system 300 and/or by storage media (not shown) disposed within the personal media device 200. A video portion of the selected viewing content 210 thereby can be presented via the video presentation system 362 of the vehicle information system 300 and/or the video display system 240 of the personal media device 200. The audio presentation system 364 of the vehicle information system 300 and/or the audio system 250 of the personal media device 200 can be used to present an audio portion of the selected viewing content 210. If the video display system 240 of the personal media device 200 is much smaller than the video presentation system 362 of the vehicle information system 300, a passenger may prefer to view the selected viewing content 210 via the larger video presentation system 362.

When no longer in use and/or direct physical contact with the personal media device 200 is not otherwise required, the personal media device 200 can be stored at the passenger seat 382. For example, the passenger seat 382 can include a storage compartment 389 for providing storage of the personal media device 200. The storage compartment 389 can be provided in any conventional manner and at any suitable portion of the passenger seat 382. As illustrated with passenger seat 382B, the personal media device 200 can be placed in a storage pocket 389B formed in the armrest 388 of the passenger seat 382B. The storage compartment 389 likewise can be provided on the seatback 386 and/or the headrest 384 of the passenger seat 382. Storage compartment 389A of passenger seat 382A, for example, is shown as being formed on the lower seatback 386 of the passenger seat 382A. As desired, the storage compartment 389 can comprise an overhead storage compartment, a door storage compartment, a storage compartment provided underneath the passenger seat 382, or any other type of conventional storage compartment, such as a glove compartment, trunk, or closet, available in the passenger vehicle 390.

FIG. 4 illustrates a conventional content distribution system 320 for vehicle information systems 300. The content distribution system 320 of FIG. 4 couples, and supports communication between a head end system 310H, which includes the content sources 310, and the plurality of user interface systems 360. The distribution system 320 as shown in FIG. 4 is provided in the manner set forth co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006, and in U.S. Pat. Nos. 5,596,647, 5,617,331, and 5,953,429, each entitled “INTEGRATED VIDEO AND AUDIO SIGNAL DISTRIBUTION SYSTEM AND METHOD FOR USE ON COMMERCIAL AIRCRAFT AND OTHER VEHICLES,” which are assigned to the assignee of the present application and the respective disclosures of which are hereby incorporated herein by reference in their entireties.

The content distribution system 320, for example, can be provided as a conventional wired and/or wireless communication network, including a telephone network, a local area network (LAN), a wide area network (WAN), a campus area network (CAN), personal area network (PAN) and/or a wireless local area network (WLAN), of any kind. Exemplary wireless local area networks include wireless fidelity (Wi-Fi) networks in accordance with Institute of Electrical and Electronics Engineers (IEEE) Standard 802.11 and/or wireless metropolitan-area networks (MANs), which also are known as WiMax Wireless Broadband, in accordance with IEEE Standard 802.16. Preferably being configured to support high data transfer rates, the content distribution system 320 preferably comprises a high-speed Ethernet network, such as any type of Fast Ethernet (such as 100Base-X and/or 100Base-T) communication network and/or Gigabit (such as 1000Base-X and/or 1000Base-T) Ethernet communication network, with a typical data transfer rate of at least approximately one hundred megabits per second (100 Mbps). To achieve high data transfer rates in a wireless communications environment, free-space optics (or laser) technology, millimeter wave (or microwave) technology, and/or Ultra-Wideband (UWB) technology can be utilized to support communications among the various system resources, as desired.

As desired, the distribution system 320 likewise can include a network management system (not shown) provided in the manner set forth in co-pending U.S. patent applications, entitled “SYSTEM AND METHOD FOR IMPROVING NETWORK RELIABILITY,” Ser. No. 10/773,523, filed on Feb. 6, 2004, and entitled “SYSTEM AND METHOD FOR IMPROVING NETWORK RELIABILITY,” Ser. No. 11/086,510, filed on Mar. 21, 2005, which are assigned to the assignee of the present application and the respective disclosures of which are hereby incorporated herein by reference in their entireties.

As illustrated in FIG. 4, the distribution system 320 can be provided as a plurality of area distribution boxes (ADBs) 322, a plurality of floor disconnect boxes (FDBs) 323, and a plurality of seat electronics boxes (SEBs) (and/or premium seat electronics boxes (PSEBs)) 324 being configured to communicate in real time via a plurality of wired and/or wireless communication connections 325. The distribution system 320 likewise can include a switching system 321 for providing an interface between the distribution system 320 and the head end system 310H. The switching system 321 can comprise a conventional switching system, such as an Ethernet switching system, and is configured to couple the head end system 310H with the area distribution boxes 322. Each of the area distribution boxes 322 is coupled with, and communicates with, the switching system 321.

Each of the area distribution boxes 322, in turn, is coupled with, and communicates with, at least one floor disconnect box 323. Although the area distribution boxes 322 and the associated floor disconnect boxes 323 can be coupled in any conventional configuration, the associated floor disconnect boxes 323 preferably are disposed in a star network topology about a central area distribution box 322 as illustrated in FIG. 4. Each floor disconnect box 323 is coupled with, and services, a plurality of daisy-chains of seat electronics boxes 324. The seat electronics boxes 324, in turn, are configured to communicate with the user interface systems 360. Each seat electronics box 324 can support one or more of the user interface systems 360.

The switching systems 321, the area distribution boxes (ADBs) 322, the floor disconnect boxes (FDBs) 323, the seat electronics boxes (SEBs) (and/or premium seat electronics boxes (PSEBs)) 324, and other system resources of the content distribution system 320 preferably are provided as line replaceable units (LRUs) (not shown). The use of LRUs facilitate maintenance of the vehicle information system 300 because a defective LRU can simply be removed from the vehicle information system 300 and replaced with a new (or different) LRU. The defective LRU thereafter can be repaired for subsequent installation. Advantageously, the use of LRUs can promote flexibility in configuring the content distribution system 320 by permitting ready modification of the number, arrangement, and/or configuration of the system resources of the content distribution system 320. The content distribution system 320 likewise can be readily upgraded by replacing any obsolete LRUs with new LRUs.

As desired, the floor disconnect boxes (FDBs) 323 advantageously can be provided as routing systems and/or interconnected in the manner set forth in the above-referenced co-pending U.S. patent application, entitled “SYSTEM AND METHOD FOR ROUTING COMMUNICATION SIGNALS VIA A DATA DISTRIBUTION NETWORK,” Ser. No. 11/277,896, filed on Mar. 29, 2006. The distribution system 320 can include at least one FDB internal port bypass connection 325A and/or at least one SEB loopback connection 325B. Each FDB internal port bypass connection 325A is a communication connection 325 that permits floor disconnect boxes 323 associated with different area distribution boxes 322 to directly communicate. Each SEB loopback connection 325B is a communication connection 325 that directly couples the last seat electronics box 324 in each daisy-chain of seat electronics boxes 324 for a selected floor disconnect box 323 as shown in FIG. 4. Each SEB loopback connection 325B therefore forms a loopback path among the daisy-chained seat electronics boxes 324 coupled with the relevant floor disconnect box 323.

An exemplary embodiment of the optical distribution system 120 suitable for use with vehicle information systems 300 is illustrated in FIG. 5. The optical distribution system 120 advantageously can provide the same features and/or connectivity described above with reference to the distribution system 320 (shown in FIG. 4) and additionally includes the benefits of being light weight, compact, and requiring little, if any, electrical power. Turning to FIG. 5, the optical distribution system 120 is shown as comprising at least one optical splitter/combiner system 124 that couples, and supports communication among, the various system resources 105. The system resources 105 of the vehicle information system 300 include the head end system 310H and a plurality of the user interface systems 360. The head end system 310H can include a content source 310, such as a server system 310A, and a switching system 321 each being provided in the manner set forth above with reference to FIG. 4. An electrical communication connection 129A couples the server system 310A and the switching system 321. The server system 310A and the switching system 321 thereby can exchange electrical communication signals 140A.

The head end system 310H can couple directly, and/or indirectly as illustrated in FIG. 5, to the optical distribution system 120. For example, the head end system 310H can couple with the optical distribution system 120 indirectly via one or more optical transceiver systems 122. The optical transceiver systems 122 provide a link interface between the head end system 310H and the optical distribution system 120 for supporting the transmission and/or reception of optical communication signals 140B among the head end system 310H and the user interface systems 360 via the optical distribution system 120. Comprising a conventional optical transceiver systems, each optical transceiver system 122 is shown as exchanging electrical communication signals 140A with the switching system 321 via an electrical communication connection 129A and as exchanging optical communication signals 140B with the optical distribution system 120 via an optical communication connection 128. Although shown and described as being integrated with the head end system 310H for purposes of illustration only, the optical transceiver systems 122 each can be separate from the head end system 310H and/or disposed within the optical distribution system 120, as desired.

Each optical transceiver system 122 can have an electrical interface system 122A that can receive incoming electrical communication signals 140A from the switching system 321 and can convert the incoming electrical communication signals 140A into outgoing optical communication signals 140B for transmission via the optical distribution system 120. The optical transceiver system 122 likewise can include an optical interface system 122B that can receive incoming optical communication signals 140B from the optical distribution system 120 and can convert the incoming optical communication signals 140B into outgoing electrical communication signals 140A for transmission to, and further processing by, the switching system 321. The optical interface system 122B can include a transmitter system (or port) 122T (shown in FIG. 8A) and a receiver system (or port) 122R (shown in FIG. 8A). The transmitter system 122T of the optical transceiver system 122 can have a light source (or optical transmitter), such as a laser or light emitting diode (LED), that injects the outgoing optical communication signals 140B into the relevant fiber optic communication connection 128. The incoming optical communication signals 140B received by the optical transceiver system 122 via the optical communication connection 128 can be sensed by an optical detector system of the receiver system 122R.

The optical distribution system 120 can be provided with any conventional network topology and, for purposes of illustration only, is shown in FIG. 5 as being provided in a point to multiple points topology. The head end system 310H thereby can communicate with each of the user interface systems 360 via the optical distribution system 120. Each optical transceiver system 122 of the head end system 310H is shown as being coupled with a respective optical splitter/combiner system 124 via an optical communication connection 128. The optical splitter/combiner systems 124 enable each optical transceiver system 122 of the head end system 310H to communicate with one or more selected user interface systems 360. Although shown and described as being an integrated system for purposes of illustration only, the optical splitter/combiner systems 124 can be provided in any conventional manner and may be provided, for example, as separate optical splitter systems and optical combiner systems.

As illustrated in FIG. 5, each optical splitter/combiner system 124 can include an aggregation port 124A and a predetermined number N (shown in FIGS. 6A-B) of fraction ports 124F. The optical splitter/combiner system 124 can receive incoming optical communication signals 140B from the head end system 310H via the aggregation port 124A and route the incoming optical communication signals 140B to each of the fraction ports 124F. The incoming optical communication signals 140B thereby can be uniformly (or equally) distributed to each fraction port 124F of the optical splitter/combiner system 124. Preferably, the outgoing optical communication signals 140B provided by each of the N fraction ports 124F is not distorted and has one-N^{th} (1/N) of the power of the incoming optical communication signals 140B received by the aggregation port 124A of the optical splitter/combiner system 124. Stated somewhat differently, the optical splitter/combiner system 124 preferably prevents leaking among the fraction ports 124F. The optical splitter/combiner system 124 likewise can receive incoming optical communication signals 140B from the user interface systems 360 via the fraction ports 124F and can combine the incoming optical communication signals 140B received by each fraction port 124F to form composite optical communication signals 140B. Each incoming optical communication signal 140B provides one-N^{th} (1/N) of the resultant power of the composite optical communication signal 140B. The composite optical communication signals 140B can be provided to the head end system 310H via the aggregation port 124A.

The user interface systems 360 likewise can couple directly, and/or indirectly as illustrated in FIG. 5, to the optical distribution system 120. For example, a selected user interface system 360 can couple with the optical distribution system 120 indirectly via an optical transceiver system 126. In the manner discussed above with reference to the optical transceiver systems 122, the optical transceiver system 126 provides a link interface between the selected user interface system 360 and the optical distribution system 120 for supporting the transmission and/or reception of optical communication signals 140B among the head end system 310H and the user interface systems 360 via the optical distribution system 120. Each optical transceiver system 126 can comprise a conventional optical transceiver system and is shown as exchanging electrical communication signals 140C with a relevant user interface system 360 via an electrical communication connection 129C and as exchanging optical communication signals 140B with the optical distribution system 120 via an optical communication connection 128. Although shown and described as being integrated with the user interface systems 360 for purposes of illustration only, the optical transceiver systems 122 can be separate from the user interface systems 360 and/or disposed within the optical distribution system 120, as desired.

Each optical transceiver system 126 can be provided in the manner set forth above with reference to the optical transceiver systems 122. For example, each optical transceiver system 126 can have an optical interface system 126B that can receive incoming optical communication signals 140B from the optical distribution system 120 and can convert the incoming optical communication signals 140B into outgoing electrical communication signals 140C for transmission to, and further processing by, the relevant user interface system 360. The optical transceiver system 126 likewise can include an electrical interface system 126A that can receive incoming electrical communication signals 140C from the relevant user interface system 360 and can convert the incoming electrical communication signals 140C into outgoing optical communication signals 140B for transmission via the optical distribution system 120.

As shown in FIG. 5, each fraction port 124F of the optical splitter/combiner systems 124 can couple with the optical interface systems 126B of the optical transceiver systems 126 via fiber optic communication connections 128. Each user interface system 360 thereby can receive the incoming optical communication signals 140B from the relevant optical splitter/combiner system 124 of the optical distribution system 120. The optical transceiver systems 126 can converts the incoming optical communication signals 140B into the electrical communication signals 140C, which are provided to the user interface systems 360 via the electrical communication connections 129C. Each system resource 105, including the head end system 310H and the selected user interface systems 360, of the vehicle information system 300 thereby can communicate via the optical distribution system 120. Being light weight, compact, and requiring little, if any, electrical power, the optical distribution system 120 advantageously supports full communications among the system resources 105 of the vehicle information system 300, while reducing the costs of operating and transporting the vehicle information system 300 aboard a passenger vehicle 390.

In operation, the head end system 310H can transmit communication signals 140 that include viewing content 210 (shown in FIGS. 2A-B), including any other data and/or control information, to the user interface systems 360 via the optical distribution system 120. Although the head end system 310H can provide different communication signals 140 to each system resource 105, the head end system 310H preferably provides uniform communication signals 140 to the user interface systems 360. In other words, the head end system 310H provides the same electrical communication signals 140A to each optical transceiver system 122, and the optical transceiver system 122 provide the same optical communication signals 140B to each optical splitter/combiner system 124 of the optical distribution system 120. The communication signals 140B received by each user interface system 360 thereby comprise uniform communication signals 140 that include the same viewing content 210.

As desired, the user interface systems 360 can identify relevant viewing content 210 included with the uniform incoming communication signals 140. The head end system 310H, for example, can encode routing information with the viewing content 210 to facilitate identification of the relevant viewing content 210 by each user interface system 360. In one embodiment, each user interface system 360 can be associated with a unique address, and the head end system 310H can label (or encode) each instance of viewing content 210 with address information. Each user interface system 360 thereby can identify the relevant viewing content 210 by comparing the address information of the viewing content 210 with the unique address of the user interface system 360. If the address information of the viewing content 210 matches the unique address of the user interface system 360, the user interface system 360 can present the viewing content 210. The user interface system 360 can discard any viewing content 210 that is not addressed to the user interface system 360.

Each of the user interface systems 360 likewise can transmit communication signals 140 that include viewing content 210, including any other data and/or control information, to the head end system 310H via the optical distribution system 120. For example, users (or passengers) can apply the user interface systems 360 to select viewing content 210 available from the head end system 310H and to control the presentation of the selected viewing content 210. In the manner set forth above, the user interface systems 360 typically can include a user input system 366 (shown in FIGS. 3A-B) for permitting the user to transmit control information to the head end system 310H as well as a user interface system 360 can include a video interface system 362 (shown in FIGS. 3A-B) and/or an audio interface system 364 (shown in FIGS. 3A-B) for presenting a video portion and/or an audio portion, respectively, of the selected viewing content 210.

In the manner set forth in the above-referenced co-pending U.S. patent applications, entitled “SYSTEM AND METHOD FOR DOWNLOADING FILES,” Ser. No. 10/772,565, filed on Feb. 4, 2004; entitled “PORTABLE MEDIA DEVICE AND METHOD FOR PRESENTING VIEWING CONTENT DURING TRAVEL,” Ser. No. 11/154,749, filed on Jun. 15, 2005; and entitled “SYSTEM AND METHOD FOR RECEIVING BROADCAST CONTENT ON A MOBILE PLATFORM DURING INTERNATIONAL TRAVEL,” Ser. No. 11/269,378, filed on Nov. 7, 2005, the user interface systems 360 can be separated into two or more interface groups 365.

The user interface systems 360 of FIG. 5, for example, are shown as being separated into two interface groups 365: first interface group 365H; and second interface group 365I. If the user interface systems 360 are associated with a passenger vehicle 390 (shown in FIGS. 3A-B), for example, the user interface systems 360 in the first interface group 365H can be associated with passenger seats 382 (shown in FIGS. 3A-B) within a first class section of the passenger vehicle 390; whereas, the user interface systems 360 in the second interface group 365I can be associated with passenger seats 382 within a coach class section of the passenger vehicle 390. Similarly, the interface groups 365H, 365I may be respectively associated with the operator and passengers of the passenger vehicle 390.

The functionality of the user interface systems 360 in the first interface group 365H can differ from the functionality of the user interface systems 360 in the second interface group 365I. For example, the user interface systems 360 in the first interface group 365H may be permitted to access premium content that is not available to the user interface systems 360 in the second interface group 365I. The user interface systems 360 in the second interface group 365I likewise might be required to make payment of a fee prior to permitting access to selected features of the head end system 310H; whereas, the user interface systems 360 in the first interface group 365H may not require payment of the fee to access the head end system 310H.

As illustrated in FIG. 5A, each interface group 365 can comprise the user interface systems 360 that are associated with a selected optical transceiver system 122. The interface group 365H includes the user interface systems 360 that are coupled with optical transceiver system 122H via optical splitter/combiner system 124H; whereas, the user interface systems 360 that are coupled with optical transceiver system 122I via optical splitter/combiner system 124I form interface group 365I. The head end system 310 thereby can manage the viewing content 210 (shown in FIGS. 2A-B) provided to each interface group 365 by managing the viewing content 210 provided to each optical transceiver system 122. The user interface systems 360 within each interface group 365 preferably are associated with passenger seats 382 (shown in FIGS. 3A-B) within the cabin 380 (shown in FIGS. 3A-B) of a passenger vehicle 390 (shown in FIGS. 3A-B) and/or are disposed in close proximity to each other.

An exemplary optical splitter/combiner system 124 that includes the aggregation port 124A and the predetermined number N of fraction ports 124F is illustrated in FIG. 6A. Turning to FIG. 6A, the maximum number of user interface systems 360 (shown in FIG. 5) that can be coupled with a selected optical splitter/combiner system 124 typically is limited by the predetermined number N of fraction ports 124F provided by the selected optical splitter/combiner system 124. The number of user interface systems 360 that can be coupled with the selected optical splitter/combiner system 124 sometimes is referred to as being the fanout of the optical splitter/combiner system 124. As desired, the number of user interface systems 360 that can be coupled with the selected optical splitter/combiner system 124 can be less than the predetermined number N of fraction ports 124F provided by the selected optical splitter/combiner system 124. The selected optical splitter/combiner system 124 thereby includes one or more spare fraction ports 124F for coupling with the user interface systems 360. The spare fraction ports 124F of the selected optical splitter/combiner system 124 can be coupled with the user interface systems 360 in case one of the used fraction ports 124F fails or otherwise malfunctions.

To increase the number of user interface systems 360 than can be coupled with the selected optical splitter/combiner system 124 (or the fanout of the selected optical splitter/combiner system 124), the selected optical splitter/combiner system 124 can be provided as a multi-stage optical splitter/combiner system as illustrated in FIG. 6B. FIG. 6B shows the selected optical splitter/combiner system 124 as being a two-stage optical splitter/combiner system 124X, 124Y. Each stage of the two-stage optical splitter/combiner system 124X, 124Y can be provided an any conventional location within the optical distribution system 120. For example, the optical splitter/combiner systems 124X associated with the first stage of the two-stage optical splitter/combiner system 124X, 124Y can be disposed adjacent to the head end system 310H (shown in FIG. 5) of the vehicle information system 300 (shown in FIG. 5); whereas, the optical splitter/combiner systems 124Y associated with the second stage can be disposed adjacent to the user interface systems 360 (shown in FIG. 5) of the vehicle information system 300. In other words, each optical splitter/combiner system 124Y can be associated with a selected interface group 365 (shown in FIG. 5) of the user interface systems 360.

Each optical splitter/combiner system 124X associated with the first stage of the two-stage optical splitter/combiner system 124X, 124Y can include an aggregation port 124A that is coupled with an optical interface system 122B (shown in FIG. 5) of a relevant optical transceiver system 122 (shown in FIG. 5). At least one of the fraction ports 124F of the optical splitter/combiner systems 124X can be coupled with the aggregation port 124A of an optical splitter/combiner systems 124Y associated with the second stage of the two-stage optical splitter/combiner system 124X, 124Y. As illustrated in FIG. 6B, for example, the first fraction port 124F of the optical splitter/combiner system 124X is coupled with the aggregation port 124A of the optical splitter/combiner system 124Y₁. The second fraction port 124F of the optical splitter/combiner system 124X is illustrated as being coupled with the aggregation port 124A of the optical splitter/combiner system 124Y₂; whereas, the N^{th} fraction port 124F of the optical splitter/combiner system 124X is shown as being coupled with the aggregation port 124A of the optical splitter/combiner system 124Y_{N}. Each optical splitter/combiner system 124 can include any suitable uniform and/or different number of fraction ports 124F, as desired. Although shown and described as a two-stage optical splitter/combiner system for purposes of illustration only, the selected optical splitter/combiner system 124 can be provided with any suitable number of stages of optical splitter/combiner system 124 to achieve the desired fanout of the selected optical splitter/combiner system 124.

Returning briefly to FIG. 5, an exemplary vehicle information system 300 can comprise five hundred user interface systems 360 and a head end system 30 having optical transceiver systems 122 each supporting a communication data rate of six megabits per second (Mbit/s or Mbps) with up to one hundred, twenty-eight user interface systems 360. To support the five hundred user interface systems 360, the head end system 310H preferably includes at least five (five hundred user interface systems 360 divided by one hundred, twenty-eight user interface systems 360 supported per optical transceiver system 122). The optic communication connections 128 that couple each optical transceiver system 122 with up to one hundred, twenty-eight associated user interface systems 360 thereby preferably support a total communication data rate of seven hundred, sixty-eight megabits per second to provide six megabits per second data rate communications with each of the associated user interface systems 360.

The optical communication signals 140B transmitted by the optical transceiver systems 122 can be provided to the up to one hundred, twenty-eight associated user interface systems 360 via an optical splitter/combiner system 124 in the manner set forth above with reference to FIGS. 5 and 6A-B. An illustrative optical splitter/combiner system 124, for example, can be provided as a two-stage optical splitter/combiner system 124X, 124Y (shown in FIG. 6B), wherein the first-stage optical splitter/combiner system 124X comprises a one-to-four optical splitter/combiner system and the four second-stage optical splitter/combiner systems 124Y₁, 124Y₂, 124Y₃, 124Y₄, each comprise one-to-thirty-two optical splitter/combiner systems. The first-stage optical splitter/combiner system 124X thereby has one aggregation port 124A and four fraction ports 124F; whereas, each second-stage optical splitter/combiner system 124Y₁, 124Y₂, 124Y₃, 124Y₄ has one aggregation port 124A and eight fraction ports 124F.

In the manner set forth in more detail above with reference to FIG. 6B, the aggregation port 1 24A of the first-stage optical splitter/combiner system 124X can be coupled with an optical interface system 122B of a relevant optical transceiver system 122. The fourth fraction ports 124F of the first-stage optical splitter/combiner system 124X can be respectively coupled with the aggregation ports 124A of the four second-stage optical splitter/combiner systems 124Y₁, 124Y₂, 124Y₃, 124Y₄. The thirty-two fraction ports 124F of the second-stage optical splitter/combiner systems 124Y₁, 124Y₂, 124Y₃, 124Y₄, in turn, can be coupled with up to thirty-two associated user interface systems 360 via optical transceiver systems 126. The optical communication signals 140B transmitted by the relevant optical transceiver system 122 thereby can be provided to the up to one hundred, twenty-eight associated user interface systems 360 via the two-stage optical splitter/combiner system 124X, 124Y.

As desired, the user interface systems 360 coupled with a selected second-stage optical splitter/combiner system 124Y₁, 124Y₂, 124Y₃, 124Y₄ can be grouped together to form an interface group 365 in the manner discussed in more detail above with reference to FIG. 5. Each interface group 365 in the present example can include up to thirty-two user interface systems 360 because up to thirty-two user interface systems 360 can couple with the second-stage optical splitter/combiner systems 124Y₁, 124Y₂, 124Y₃, 124Y₄. The user interface systems 360 forming a selected interface group 365 preferably are associated with passenger seats 382 (shown in FIGS. 3A-B) within the cabin 380 (shown in FIGS. 3A-B) of a passenger vehicle 390 (shown in FIGS. 3A-B) and/or are disposed in close proximity to each other.

The user interface systems 360 can transmit the communication signals 140 to the head end system 310H in accordance with any conventional communication protocol. As illustrated in FIGS. 7A-D, for example, the user interface systems 360 can transmit each of the optical communication signals 140W-Z to a selected optical splitter/combiner system 124 as a plurality of communication signal bursts 142. FIG. 7A is an exemplary timing diagram that illustrates the optical communication signal 140W output from a selected first user interface system 360. The optical communication signal 140W can be encoded with address information associated with the unique address of the first user interface system 360 and provided to a first fraction port 124F of the selected optical splitter/combiner system 124 as a series of periodic communication signal bursts 142. Each encoded communication signal burst 142 is shown as occurring during a burst window T. Within each burst window T, the optical communication signal 140W can comprise a high-speed sequential bit stream with viewing content 210 that propagates to the first fraction port 124F of the selected optical splitter/combiner system 124. Outside of the burst windows T, the optical communication signal 140W preferably provides no optical power to the first fraction port 124F.

Turning to FIGS. 7B-C, the optical communication signals 140X, 140Y each are respectively provided by selected second and third user interface systems 360 to second and third fraction ports 124F of the selected optical splitter/combiner system 124. Like the optical communication signal 140W, the optical communication signals 140X, 140Y each comprise a series of periodic communication signal bursts 142 that occur within burst windows T. The optical communication signals 140X, 140Y each can be encoded with address information associated with the respective unique addresses of the second and third user interface systems 360. As shown in FIGS. 7B-C, the optical communication signals 140X, 140Y can comprise encoded communication signal bursts 142 of sequential bit streams that propagate to the second and third fraction ports 124F, respectively, of the selected optical splitter/combiner system 124 during each burst window T and preferably provide no optical power to the second and third fraction ports 124F outside of the burst windows T.

Each remaining user interface system 360, such as an N^{th} user interface system 360 as illustrated in FIG. 7D, that is coupled with an N^{th} fraction port 124F of the selected optical splitter/combiner system 124 likewise provides a optical communication signal 140, such as optical communication signal 140Z, that comprises a series of periodic communication signal bursts 142. Each optical communication signal 140W-Z thereby comprises encoded communication signal bursts 142 of sequential bit streams with viewing content 210 that propagate to a relevant fraction port 124F of the selected optical splitter/combiner system 124 during the associated burst windows T and preferably provides no optical power to the relevant fraction ports 124F outside of the burst windows T. As set forth above in more detail above, the optical communication signal 140W-Z can be encoded with address information associated with the unique address of the associated user interface system 360.

As illustrated in FIGS. 7A-D, the burst windows T (or encoded communication signal bursts 142) of the optical communication signal 140W-Z are offset in time. Only one of the user interface systems 360 transmits an encoded communication signal burst 142 to the selected optical splitter/combiner system 124 at a time. In other words, the optical communication signal 140W-Z preferably are synchronized in time to avoid overlaps among the encoded communication signal bursts 142. To help avoid signal interference among the optical communication signal 140W-Z, the encoded communication signal burst 142 of the optical communication signal 140W-Z are illustrated in FIGS. 7A-D as being separated by a time tolerance band t, wherein none of the user interface systems 360 provide optical power to the selected optical splitter/combiner system 124. Although shown and described as being substantially uniform for purposes of illustration only, the burst windows T and/or time tolerance bands t can have different values within a selected the optical communication signal 140W-Z and/or among optical communication signals 140W-Z.

In the manner set forth above with reference to FIG. 5, the selected optical splitter/combiner system 124 receives each of the optical communication signals 140W-Z via the fraction ports 124F and can combine the incoming optical communication signals 140W-Z to form a composite optical communication signal 140C as illustrated in FIG. 7E. Turning to FIG. 7E, the composite optical communication signal 140C is shown as comprising an interleaved (or multiplexed) sequence of encoded communication signal burst 142 as provided by the optical communication signals 140W-Z. Since the optical communication signal 140W-Z are synchronized in time, the encoded communication signal bursts 142 of the composite optical communication signal 140C are shown as discrete communication signal bursts 142 that do not overlap in time. The time tolerance band t likewise helps to avoid signal interference between adjacent communication signal bursts 142 in the manner discussed above.

The selected optical splitter/combiner system 124 can provide the composite optical communication signal 140C to the head end system 310H (shown in FIG. 5) in the manner set forth above. More specifically, the optical transceiver system 122 (shown in FIG. 5) can receive the composite optical communication signal 140C from the selected optical splitter/combiner system 124 and can convert the composite optical communication signal 140C into a composite electrical communication signal (not shown) for transmission to, and further processing by, the switching system 321 (shown in FIG. 5) and/or the server system 310A (shown in FIG. 5) of the head end system 310H. Based upon the address information encoded into the encoded communication signal bursts 142 of the composite electrical communication signal, the head end system 310H can de-interleave (or de-multiplex) and/or decode the encoded communication signal bursts 142 to identify the viewing content 210 (shown in FIGS. 3A-B), including any data and/or control information, transmitted by each user interface system 360. The head end system 310H thereby can generate an appropriate response to each user interface system 360.

Alternatively, and/or additionally, the optical transceiver systems 122 associated with the head end system 310H of the vehicle information system 300 and the optical transceiver system 126 associated with a selected user interface system 360 can be configured to communicate via a single fiber optic communication connection 128A of the optical distribution system 120. Use of the single fiber optic communication connection 128A that supports bidirectional communications between the head end system 310H and the selected user interface system 360 advantageously can increase operational efficiency of the vehicle information system 300 and facilitate installation of the vehicle information system 300 with in the vehicle 390 (shown in FIGS. 2A-B).

Turning to FIG. 8A, for example, the optical distribution system 120 can include at least one wavelength-division multiplexer (WDM) system 123, 125. Each wavelength-division multiplexer system 123, 125 preferably is disposed adjacent to the associated optical transceiver system 122, 126. The optical transceiver system 122 is shown as communicating with the single fiber optic communication connection 128A via the wavelength-division multiplexer system 123; whereas, the wavelength-division multiplexer system 125 couples the single fiber optic communication connection 128A with the optical transceiver system 126. The wavelength-division multiplexer systems 123, 125 enable the head end system 310H and the selected user interface system 360 to support bidirectional exchanges of optical communication signals 140B via the single fiber optic communication connection 128A.

The single fiber optic communication connection 128A thereby can transmit downstream optical communication signals 140D provided by the head end system 310H to the selected user interface system 360 and upstream optical communication signals 140U provided by the selected user interface system 360 to the head end system 310H. The wavelength-division multiplexer systems 123, 125 can be advantageously applied to the vehicle information system 300, for example, when an optical wavelength of the downstream optical communication signals 140D is different from an optical wavelength of the upstream optical communication signals 140U. The upstream optical communication signals 140U transmitted by each user interface system 360 of the vehicle information system 300 preferably have optical wavelengths that are approximately uniform.

The wavelength-division multiplexer system 123 is shown as including a downstream optical communication port 123D, an upstream optical communication port 123U, and a combined optical communication port 123C. As illustrated in FIG. 8A, the downstream and upstream optical communication ports 123D, 123U are respectively coupled with the transmitter and receiver systems (or ports) 122T, 122R of the optical transceiver system 122 via optical communication connections 128; whereas, the combined optical communication port 123C is coupled to the single fiber optic communication connection 128A. The combined optical communication port 123C of the wavelength-division multiplexer system 123 thereby can receive the upstream optical communication signals 140U transmitted by the selected user interface system 360 via the single fiber optic communication connection 128A. The wavelength-division multiplexer system 123 can route the upstream optical communication signals 140U from the combined optical communication port 123C to the upstream optical communication port 123U, and the upstream optical communication port 123U can provide the upstream optical communication signals 140U to the receiver system port 122R of the optical transceiver system 122 and, thus, to the head end system 310H.

Similarly, the downstream optical communication port 123D of the wavelength-division multiplexer system 123 can receive the downstream optical communication signals 140D provided by the transmitter port 122T of the optical transceiver system 122 that is associated with the head end system 310H. The upstream optical communication port 123U of the wavelength-division multiplexer system 123 preferably does not permit leakage of the downstream optical communication signals 140D into the receiver port 122R of the optical transceiver system 122; whereas, the downstream optical communication port 1 23D preferably does not permit leakage of the upstream optical communication signals 140U into the transmitter port 122T of the optical transceiver system 122. The wavelength-division multiplexer system 123 can route the downstream optical communication signals 140D from the downstream optical communication port 123D to the combined optical communication port 123C. The combined optical communication port 123C can provide the upstream optical communication signals 140U to the single fiber optic communication connection 128A and, accordingly, to the selected user interface system 360. The wavelength-division multiplexer system 123 thereby enables the head end system 310H to support bidirectional exchanges of optical communication signals 140B via the single fiber optic communication connection 128A.

The wavelength-division multiplexer system 125 can be provided in the manner set forth above with reference to the wavelength-division multiplexer system 123 and is illustrated as including a downstream optical communication port 125D, an upstream optical communication port 125U, and a combined optical communication port 125C. The downstream and upstream optical communication ports 125D, 125U are coupled with the receiver and transmitter systems (or ports) 122R, 122T, respectively, of the optical transceiver system 126 via optical communication connections 128, and the combined optical communication port 125C is coupled to the single fiber optic communication connection 128A. In the manner set forth in more detail above, the combined optical communication port 125C of the wavelength-division multiplexer system 125 can receive downstream optical communication signals 140D transmitted by the head end system 310H via the single fiber optic communication connection 128A. The wavelength-division multiplexer system 125 can route the downstream optical communication signals 140D from the combined optical communication port 125C to the downstream optical communication port 125D, which can provide the downstream optical communication signals 140D to the receiver port 122R of the optical transceiver system 126 and, thereby, to the selected user interface system 360.

The upstream optical communication port 125U of the wavelength-division multiplexer system 125 likewise can receive upstream optical communication signals 140U transmitted by the transmitter port 122T of the optical transceiver system 126 of the selected user interface system 360. As set forth above with reference to the wavelength-division multiplexer system 123, the upstream optical communication port 125U of the wavelength-division multiplexer system 125 preferably does not permit leakage of the downstream optical communication signals 140D into the transmitter port 126T of the optical transceiver system 126; whereas, the downstream optical communication port 125D preferably does not permit leakage of the upstream optical communication signals 140U into the receiver port 126R of the optical transceiver system 126. The wavelength-division multiplexer system 125 can route the upstream optical communication signals 140U from the upstream optical communication port 125U to the combined optical communication port 125C. The combined optical communication port 125C can provide the upstream optical communication signals 140U to the single fiber optic communication connection 128A and, therefore, to the head end system 310OH. Thereby, the wavelength-division multiplexer system 125 enables the selected user interface system 360 to support bidirectional exchanges of optical communication signals 140B via the single fiber optic communication connection 128A.

As desired, the head end system 310H and the selected user interface system 360 can exchange the upstream and downstream optical communication signals 140U, 140D directly as illustrated in FIG. 8A and/or indirectly via one or more intermediate systems. Turning to FIG. 8B, for example, the optical distribution system 120 is shown as including at least one optical splitter/combiner system 124 for facilitating indirect communications between the head end system 310H and the selected user interface system 360 by way of the single fiber optic communication connection 128B, 128C. In other words, the head end system 310H and the selected user interface system 360 can exchange the upstream and downstream optical communication signals 140U, 140D via the optical splitter/combiner system 124.

Being provided in the manner set forth in more detail above with reference to FIG. 5, the optical splitter/combiner system 124 enables the optical transceiver system 122 to communicate with one or more optical transceiver systems 126 and can include an aggregation port 124A and a predetermined number N (shown in FIGS. 6A-B) of fraction ports 124F. The wavelength-division multiplexer system 123 communicates with the head end system 310H in the manner discussed above with reference to FIG. 8A. As shown in FIG. 8B, the combined optical communication port 123C of the wavelength-division multiplexer system 123 is coupled with the aggregation port 124A of the optical splitter/combiner system 124 by way of the optical communication connection 128B.

The wavelength-division multiplexer system 125 likewise communicates with the selected user interface system 360 in the manner discussed above with reference to FIG. 8A. The optical communication connection 128C is shown as coupling a selected fraction port 124F of the optical splitter/combiner system 124 with the combined optical communication port 125C of the wavelength-division multiplexer system 125. As desired, other user interface systems 360 can be associated with wavelength-division multiplexer systems 125, which can be coupled with the remaining fraction ports 124F of the optical splitter/combiner system 124 in a similar manner.

In operation, the wavelength-division multiplexer system 123 associated with the head end system 310H can provide the downstream optical communication signals 140D in the manner set forth above. The optical communication connection 128B can provide transport the downstream optical communication signals 140D transmitted from the combined optical communication port 123C of the wavelength-division multiplexer system 123 to the aggregation port 124A of the optical splitter/combiner system 124. The optical splitter/combiner system 124 can receive the downstream optical communication signals 140D and route the downstream optical communication signals 140D to the fraction ports 124F. Thereby, the downstream optical communication signals 140D can be provided to the combined optical communication port 125C of the wavelength-division multiplexer system 125 via the optical communication connection 128C. The wavelength-division multiplexer system 125 and, therefore, the selected user interface system 360 can receive the downstream optical communication signals 140D in the manner discussed above.

The selected user interface system 360 likewise can transmit the upstream optical communication signals 140U to the optical distribution system 120 via the wavelength-division multiplexer system 125 in the manner set forth in more detail above. The optical communication connection 128C can provide transport the upstream optical communication signals 140U transmitted from the combined optical communication port 125C of the wavelength-division multiplexer system 125 to the relevant fraction port 124F of the optical splitter/combiner system 124. In the manner discussed above, the optical splitter/combiner system 124 can receive the upstream optical communication signals 140U and can combine upstream optical communication signals received by other fraction ports 124F to form the composite optical communication signals 140B (shown in FIG. 5). The composite optical communication signals 140B include the upstream optical communication signals 140U.

The upstream optical communication signals 140U thereby can be provided to the combined optical communication port 123C of the wavelength-division multiplexer system 123 via the optical communication connection 128B. The wavelength-division multiplexer system 123 and, therefore, the head end system 310H can receive the upstream optical communication signals 140U in the manner discussed above. Accordingly, the wavelength-division multiplexer systems 123, 125 and the optical splitter/combiner system 124 enable the optical distribution system 120 to support bidirectional exchanges of optical communication signals 140D, 140U via the single fiber optic communication connection 128B, 128C.

The optical distribution system 120 preferably incorporates redundant fiber optic communication links between the head end system 310H and the user interface systems 360. The redundant fiber optic communication links preferably includes redundancy among the system components coupling the optical transceiver systems 122 associated with the head end system 310H and the optical transceiver systems 126 associated with the user interface systems 360. In other words, the fiber optic communication links between the head end system 310H and the user interface systems 360 are provided via two physically separate communication paths. Each fiber optic communication link, for example, can be provided in the manner set forth above with reference to FIGS. 5, 6A-B, and 8A-B. The redundant fiber optic communication links advantageously eliminate a single point of failure between the head end system 310H and the user interface systems 360.

Alternatively, and/or additionally, the optical distribution system 120 can include at least one optical switching system 127 as illustrated in FIG. 9A. The optical switching system 127 can provide partial redundancy within the optical distribution system 120 by providing protection against cut optical communication connections 128 and other system failures within the optical distribution system 120. Turning to FIG. 9A, the optical switching system 127 comprises a conventional optical switching system and can include a first communication port (or connector) 127X, a second communication port (or connector) 127Y, and a common communication port (or connector) 127Z. The optical switching system 127 can be controlled to optically couple the common communication port 127Z with either the first communication port 127X or the second communication port 127Y. In other words, the optical switching system 127 has two switching states: a first switching state wherein the common communication port 127Z is optically coupled with the first communication port 127X; and a second switching state wherein the common communication port 127Z is optically coupled with the second communication port 127Y. Thereby, optical communication signals 140B can be exchanged between the common communication port 127Z and the first communication port 127X in the first switching state and between the common communication port 127Z and the second communication port 127X in the second switching state.

The head end system 310H is shown as including redundant first and second optical transceiver systems 122X, 122Y. Each optical transceiver system 122X, 122Y is provided in the manner set forth above with reference to the optical transceiver system 122 (shown in FIG. 5) and includes an optical interface system 122B. The optical interface system 122B of the first optical transceiver system 122X is shown as being coupled with the first communication port 127X of the optical switching system 127 via first optical communication connection 128X; whereas, a second optical communication connection 128Y couples the optical interface system 122B of the second optical transceiver system 122Y with the second communication port 127X of the optical switching system 127. The first optical communication connection 128X and the second optical transceiver system 122Y provide two physically separate communication paths between the head end system 310H and the optical switching system 127. The common communication port 127Z of the optical switching system 127 can be coupled with the optical transceiver system 126 associated with a selected user interface system 360 by way of third optical communication connection 128Z.

When disposed in the first switching state, the optical switching system 127 optically couples the first communication port 127X and the common communication port 127Z. The optical distribution system 120 thereby forms a first fiber optic communication link for coupling the head end system 310H with the optical switching system 127. The first fiber optic communication link includes first optical transceiver system 122X and the first optical communication connection 128X. The first optical transceiver system 122X of the head end system 310H can exchange optical communication signals 140X, 140Z with the optical transceiver system 126 of the selected user interface system 360 via the first and third optical communication connections 128X, 128Z.

Upon being alerted to a system malfunction associated with the first optical transceiver system 122X and/or the first optical communication connection 128X, the head end system 310H of the vehicle information system 300 can instruct the optical switching system 127 to enter and maintain the second switching state. In response to the instruction, the optical switching system 127 optically couples the second communication port 127Y with the common communication port 127Z, disconnecting the first optical transceiver system 122X and the first optical communication connection 128X from the optical transceiver system 126 of the selected user interface system 360. The second optical transceiver system 122Y of the head end system 310H advantageously can continue the exchange of optical communication signals 140Y, 140Z with the optical transceiver system 126 of the selected user interface system 360 via the second and third optical communication connections 128Y, 128Z in the manner discussed in my detail above despite the system malfunction. Although the optical switching system 127 can be disposed at any physical location within the optical distribution system 120, the optical switching system 127 preferably is disposed physically adjacent to the optical transceiver system 126 of the selected user interface system 360.

FIG. 9B shows an alternative embodiment of the optical distribution system 120, wherein an optical splitter/combiner system 124 is disposed between the optical switching system 127 and a plurality of optical transceiver systems 126 associated with user interface systems 360. The optical splitter/combiner system 124 is provided in the manner set forth above with reference to the optical splitter/combiner system 124 (shown in FIG. 5) and includes an aggregation port 124A and a predetermined number N (shown in FIGS. 6A-B) of fraction ports 124F. In the manner set forth above with reference to the optical distribution system 120 of FIG. 9A, the optical interface systems 122B of the first and second optical transceiver systems 122X, 122Y can be respectively coupled with the first and second communication ports 127X, 127Y of the optical switching system 127 via first and second optical communication connections 128X, 128Y. The first and optical communication connections 128X, 128Y provide two physically separate communication paths between the head end system 310H and the optical switching system 127.

The common communication port 127Z of the optical switching system 127 is shown as being coupled with the aggregation port 124A of the optical splitter/combiner system 124; whereas, the fraction ports 124F can be coupled with the optical transceiver systems 126 associated with the respective user interface system 360 by way of third optical communication connections 128Z. When disposed in the first switching state, the optical switching system 127 optically couples the first communication port 127X and the common communication port 127Z in the manner set forth above. The optical distribution system 120 thereby forms the first fiber optic communication link for coupling the head end system 310H with the optical switching system 127, and the first optical transceiver system 122X can exchange optical communication signals 140X, 140Z with the optical transceiver systems 126 of the user interface systems 360 via the first and third optical communication connections 128X, 128Z.

If a system malfunction associated with the first optical transceiver system 122X and/or the first optical communication connection 128X occurs, the optical switching system 127 to enter and maintain the second switching state, optically coupling the second communication port 127Y with the common communication port 127Z. The first optical transceiver system 122X and the first optical communication connection 128X thereby can be disconnected from the optical transceiver systems 126 of the user interface systems 360, and the second optical transceiver system 122Y of the head end system 310H and the first optical communication connection 128Y can be optically coupled with the optical transceiver systems 126 of the user interface systems 360. The second optical transceiver system 122Y advantageously can continue the exchange of optical communication signals 140Y, 140Z with the optical transceiver systems 126 of the user interface systems 360 via the second and third optical communication connections 128Y, 128Z in the manner discussed in my detail above despite the system malfunction.

FIG. 10A illustrates a generic optical system component 121 of the optical distribution system 120. The optical system component 121 can comprise any conventional optical system component, such as a optical transceiver system 122, 126 (shown in FIG. 5), a wavelength-division multiplexer (WDM) system 123, 125 (shown in FIGS. 8A-B), an optical splitter/combiner system 124 (shown in FIG. 5), and/or an optical switching system 127 (shown in FIGS. 9A-B) without limitation. As desired, the optical system component 121 can comprise a stand-alone system and/or can be associated with the head end system 3110H (shown in FIG. 5) and/or a selected user interface system 360. The optical system component 121 is enclosed within a system housing 121 S and includes at least one optical communication port (or connector) 121R. Each optical communication port 121R preferably comprises a conventional optical communication port that is disposed upon the system housing 121S and can form an opening 121T through which incoming optical communication signals 140B (shown in FIG. 5) can be received and/or outgoing optical communication signals 140B can be transmitted.

The optical communication port 121R of the optical system component 121 is shown in FIG. 10A as being coupled with an optical communication connection 128. In the manner set forth above, the optical communication connection 128 can comprise conventional fiber optic communication connection and can include a fiber optic communication cable 128S that is terminated with at least one optical communication port (or connector) 128R. Stated somewhat differently, the optical communication port 128R is provided adjacent to a selected end region of the fiber optic communication cable 128S. Preferably comprising a conventional optical communication port, the optical communication port 128R of the optical communication connection 128 can form an opening 128T through which incoming optical communication signals 140B (shown in FIG. 5) can be received and/or outgoing optical communication signals 140B can be transmitted. The optical communication port 128R is configured to cooperate with the optical communication port 121 R of the optical system component 121 as illustrated in FIG. 10A.

As illustrated in FIG. 10B, the optical communication port 128R of the optical communication connection 128 can detachably couple with the optical communication port 121R of the optical system component 121. The optical communication port 128R preferably is detachable from the optical communication port 121R by hand and without the use of any tool. When the optical communication port 128R is detached from the optical communication port 121R, the optical communication port 128R and the optical communication port 121R each are exposed and can be available for cleaning, preferably without need for a special tool.

Turning to FIG. 11A, a pair of optical communication connections 128 are shown as being coupled. Each optical communication connection 128 can be provided in the manner set forth above with reference to FIGS. 10A-B and can include a fiber optic communication cable 128S that is terminated with at least one optical communication port (or connector) 128R. The optical communication ports 128R of the optical communication connections 128 can be coupled directly or, as illustrated in FIG. 11A, indirectly via an optical adapter system 150.

Preferably comprising a conventional optical adapter system, the optical adapter system 150 is enclosed within an adaptor housing 150S and includes at least two optical communication ports (or connectors) 150R. The optical communication ports 150R are configured to cooperate with the optical communication ports 128R of the optical communication connections 128. Each optical communication port 159R preferably comprises a conventional optical communication port that is disposed upon the adaptor housing 150S and can form an opening 150T through which incoming optical communication signals 140B (shown in FIG. 5) can be received and/or outgoing optical communication signals 140B can be transmitted. The optical adapter system 150 permits optical communication signals 140B (shown in FIG. 5) to be exchanged between the optical communication ports 150R.

FIG. 11B shows that the optical communication ports 128R of the optical communication connections 128 can detachably couple with the optical communication ports 150R of the optical adapter system 150. The optical communication ports 128R preferably are detachable from the optical communication ports 150R by hand and without the use of any tool. When the optical communication ports 128R are detached from the optical communication ports 150R, the optical communication ports 128R, 150R each are exposed and can be available for cleaning, preferably without need for a special tool.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. An optical distribution system suitable for use with a vehicle information system installation aboard a passenger vehicle, comprising:
a first optical transceiver system that receives a first encoded electrical communication signal from a head end system of the vehicle information system and converts the first encoded electrical communication signal into a downstream optical communication signal, the first encoded electrical communication signal including viewing content intended for presentation via a selected user interface system of the vehicle information system, the viewing content being encoded with address information associated with the selected user interface system;
an optical splitter system that includes an aggregation port that receives the downstream optical communication signal and a predetermined number of fraction ports, said optical splitter system uniformly routing the downstream optical communication signal to each of said fraction ports; and
a plurality of second optical transceiver systems each receiving the downstream optical communication signal via a relevant fraction port and converting the downstream optical communication signal to recover the first encoded electrical communication signal, each of said second optical transceiver systems providing the first encoded electrical communication signal to an associated user interface system,
wherein the associated user interface system is associated with a unique address and compares the address information with the unique address, the associated user interface system presenting the viewing content if the address information matches the unique address and discarding the viewing content if the address information does not match the unique address.

2. The optical distribution system of claim 1, further comprising:
said second optical transceiver systems each receiving a second encoded electrical communication signal from the associated user interface system and converting the second encoded electrical communication signal into an upstream optical communication signal, the second encoded electrical communication signal including data content intended for the head end system, the data content being encoded with address information associated with the unique address of the associated user interface system;
an optical combiner system that includes an aggregation port and a predetermined number of fraction ports that receive the upstream optical communication signal from a relevant second optical transceiver, said optical combiner system combining the upstream optical communication signal received by each of said fraction ports to form a composite upstream optical communication signal; and
said first optical transceiver system receiving the composite upstream optical communication signal via said aggregation port of said optical combiner system, converting the composite upstream optical communication signal to recover the second encoded electrical communication signal, and providing the second encoded electrical communication signal to the head end system,
wherein the head end system identifies the associated user interface system based upon the address information of the data content and generates an appropriate response to the data content.

3. The optical distribution system of claim 2, wherein said optical splitter system and said optical combiner system are integrated to form an optical splitter/combiner system.

4. The optical distribution system of claim 2, further comprising:
a first wavelength-division multiplexer system that is disposed between said second optical transceiver systems and said optical combiner system, said first wavelength-division multiplexer system receiving the upstream optical communication signal and providing the upstream optical communication signal as a series of periodic communication signal bursts;
said optical combiner system combining the periodic communication signal bursts received by each of said fraction ports to form the composite upstream optical communication signal; and
a second wavelength-division multiplexer system that is disposed between said optical combiner system and said first optical transceiver, said second wavelength-division multiplexer system receiving the composite upstream optical communication signal, recovering the upstream optical communication signal, and providing the upstream optical communication signal to said first optical transceiver,
wherein the head end system and the associated user interface system communicate via a single fiber optic communication connection.

5. The optical distribution system of claim 4, wherein the upstream optical communication signal comprises a high-speed sequential bit stream during a burst window and provides no optical power outside of the burst window.

6. The optical distribution system of claim 4, wherein the upstream optical communication signal comprises a high-speed sequential bit stream during a burst window and provides no optical power outside of the burst window.

7. The optical distribution system of claim 4, wherein a wavelength of the upstream optical communication signal is different from a wavelength of the downstream optical communication signal.

8. The optical distribution system of claim 1, wherein the associated user interface system is disposed adjacent to a passenger seat.

9. The optical distribution system of claim 1, wherein the associated user interface system is disposed adjacent to a passenger seat.

10. The optical distribution system of claim 1, wherein the vehicle information system is suitable for installation aboard an aircraft.

11. A method for distributing viewing content within a vehicle information system installation aboard a passenger vehicle, comprising:
receiving a first encoded electrical communication signal from a head end system of the vehicle information system, the first encoded electrical communication signal including viewing content intended for presentation via a selected user interface system of the vehicle information system, the viewing content being encoded with address information associated with the selected user interface system;
converting the first encoded electrical communication signal into a downstream optical communication signal;
splitting the downstream optical communication signal into a predetermined number of uniform downstream optical communication signals;
converting the downstream optical communication signal to recover the first encoded electrical communication signal; and
providing the recovered first encoded electrical communication signal to an associated user interface system,
wherein the associated user interface system is associated with a unique address and compares the address information with the unique address, the associated user interface system presenting the viewing content if the address information matches the unique address and discarding the viewing content if the address information does not match the unique address.

12. An optical distribution system suitable for use with a vehicle information system installation aboard a passenger vehicle, comprising:
first and second optical transceiver systems that receive a first encoded electrical communication signal from a head end system of the vehicle information system and converts the first encoded electrical communication signal into a downstream optical communication signal, the first encoded electrical communication signal including viewing content intended for presentation via a selected user interface system of the vehicle information system, the viewing content being encoded with address information associated with the selected user interface system;
first and second optical splitter systems respectively coupled with said first and second optical transceiver systems, each of said optical splitter system including an aggregation port that receives the downstream optical communication signal and uniformly routing the downstream optical communication signal to each of a predetermined number of fraction ports; and
a plurality of third and fourth optical transceiver systems respectively coupled with said first and second optical splitter systems, said third and fourth optical transceiver systems each receiving the downstream optical communication signal via a relevant fraction port, converting the downstream optical communication signal to recover the first encoded electrical communication signal, said third optical transceiver system providing the first encoded electrical communication signal to a first associated user interface system, said fourth optical transceiver system providing the first encoded electrical communication signal to a second associated user interface system,
wherein the first and second associated user interface systems each are associated with a unique address and compares the address information with the unique address, the first and second associated user interface systems presenting the viewing content if the address information matches the unique address and discarding the viewing content if the address information does not match the unique address.

13. A vehicle information system suitable for installation aboard a passenger vehicle, comprising:
a head end system;
a plurality of user interface system; and
an optical distribution coupling said head end system with said user interface system and comprising:
a first optical transceiver system that receives a first encoded electrical communication signal from said head end system and converts the first encoded electrical communication signal into a downstream optical communication signal, the first encoded electrical communication signal including viewing content intended for presentation via a selected user interface system, the viewing content being encoded with address information associated with said selected user interface system;
an optical splitter system that includes an aggregation port that receives the downstream optical communication signal and a predetermined number of fraction ports, said optical splitter system uniformly routing the downstream optical communication signal to each of said fraction ports; and
a plurality of second optical transceiver systems each receiving the downstream optical communication signal via a relevant fraction port and converting the downstream optical communication signal to recover the first encoded electrical communication signal, each of said second optical transceiver systems providing the first encoded electrical communication signal to an associated user interface system,
wherein said associated user interface system is associated with a unique address and compares the address information with said unique address, said associated user interface system presenting the viewing content if the address information matches said unique address and discarding the viewing content if the address information does not match said unique address.

14. An aircraft, comprising:
a fuselage and a plurality of passenger seats arranged within the fuselage; and
a vehicle information system coupled with said fuselage and comprising:
a head end system that provides overall system control functions for the vehicle information system and that includes a content source;
a plurality of user interface system each including a user input system for selecting viewing content available from said head end system and a content presentation system for presenting the selected viewing content; and
an optical distribution coupling said head end system with said user interface system and comprising:
a first optical transceiver system that receives a first encoded electrical communication signal from said head end system and converts the first encoded electrical communication signal into a downstream optical communication signal, the first encoded electrical communication signal including viewing content intended for presentation via a selected user interface system, the viewing content being encoded with address information associated with said selected user interface system;
an optical splitter system that includes an aggregation port that receives the downstream optical communication signal and a predetermined number of fraction ports, said optical splitter system uniformly routing the downstream optical communication signal to each of said fraction ports; and
a plurality of second optical transceiver systems each receiving the downstream optical communication signal via a relevant fraction port and converting the downstream optical communication signal to recover the first encoded electrical communication signal, each of said second optical transceiver systems providing the first encoded electrical communication signal to an associated user interface system,
wherein said associated user interface system is associated with a unique address and compares the address information with said unique address, said associated user interface system presenting the viewing content if the address information matches said unique address and discarding the viewing content if the address information does not match said unique address.
